(19) United States
(12) Patent Application Publication
(10) Pub. No.: US 2025/0236735 A1
(43) Pub. Date: Jul. 24, 2025

(54) BIOCHAR COMPOSITE MATERIALS AND RELATED METHODS

(71) Applicant: The United States as Represented by the Secretary of Agriculture, Washington, DC (US)

(72) Inventors: Qiangu Yan, Madison, WI (US); Zhiyong Cai, Verona, WI (US); James H. Muehl, Waunakee, WI (US); Cynthia West, Middleton, WI (US)

(21) Appl. No.: 19/035,122

(22) Filed: Jan. 23, 2025

Related U.S. Application Data
(60) Provisional application No. 63/624,354, filed on Jan. 24, 2024.

(51) Int. Cl. C09C 1/56; C02F 1/28; C02F 1/62; C02F 101/20; C02F 101/36

(52) U.S. Cl. CPC C09C 1/56; C02F 1/283; C02F 1/62; C01P 2002/88; C01P 2004/03; C01P 2004/60; C02F 2101/20; C02F 2101/36

(57) ABSTRACT

A method of fabricating a biochar composite product comprises thermally treating a precursor composition by heating the precursor composition according to a heating profile to provide a biochar composite product, the precursor composition comprising biochar and a natural binder other than lignin, wherein the natural binder forms a solid, porous, covalently bound carbon matrix at or above a threshold temperature, wherein the biochar composite product comprises a plurality of porous, carbonaceous particles and the solid, porous, covalently bound carbon matrix on surfaces of particles in the plurality such that neighboring particles are adhered together. The biochar composite products and methods of using the products are also provided.

### CROSS-REFERENCE TO RELATED APPLICATIONS

The present application claims priority to U.S. provisional patent application No. 63/624,354 that was filed Jan. 24, 2024, the entire contents of which are incorporated herein by reference.

### BACKGROUND

Biochar is an organic material derived from biomass. It is particulate in form and often used as an additive that is mixed and dispersed into soils to increase aeration, limit leaching of nutrients, and increase water content. Due to its powdered morphology, biochar has relatively low mechanical properties and has found limited uses beyond soil amendment.

### SUMMARY

Provided are biochar composite materials, methods of fabricating the materials, and methods of using the materials.

An embodiment 1 is a method of fabricating a biochar composite product, the method comprising thermally treating a precursor composition by heating the precursor composition according to a heating profile to provide a biochar composite product, the precursor composition comprising biochar and a natural binder other than lignin, wherein the natural binder forms a solid, porous, covalently bound carbon matrix at or above a threshold temperature, wherein the biochar composite product comprises a plurality of porous, carbonaceous particles and the solid, porous, covalently bound carbon matrix on surfaces of particles in the plurality such that neighboring particles are adhered together.

An embodiment 2 is according to embodiment 1, wherein particles in the plurality of porous, carbonaceous particles have elongated, rectangular shapes with ragged edges and an average largest dimension in a range of from 1 mm to 100 mm.

An embodiment 3 is according to any of embodiments 1-2, wherein the biochar is unmodified biochar.

An embodiment 4 is according to any of embodiments 1-2, wherein the method further comprises exposing the biochar or the precursor composition or both to an activation agent to provide modified biochar.

An embodiment 5 is according to embodiment 4, wherein the activation agent is selected from steam, CO₂, a base, an acid, or a metal precursor.

An embodiment 6 is according to any of embodiments 1-5, wherein the natural binder is selected from the group consisting of starch, tannin, carboxymethyl cellulose, biorefinery solid residue, and bio-oil.

An embodiment 7 is according to embodiment 4, wherein the activation agent is selected from steam, a base, and an acid and wherein the natural binder is selected from the group consisting of starch, tannin, and carboxymethyl cellulose.

An embodiment 8 is according to any of embodiments 1-7, wherein the precursor composition comprises more biochar than natural binder.

An embodiment 9 is according to embodiment 8, wherein the precursor composition has a mass ratio of biochar:natural binder that is at least 2:1.

An embodiment 10 is according to any of embodiments 1-9, wherein the precursor composition consists of the biochar and the natural binder.

An embodiment 11 is according to any of embodiments 1-10, wherein the heating according to the heating profile uses a maximum temperature that is between the threshold temperature and less than 320° C.

An embodiment 12 is according to any of embodiments 1-10, wherein the heating according to the heating profile uses a maximum temperature that is between 350° C. and less than 800° C.

An embodiment 13 is according to any of embodiments 1-10, wherein the heating according to the heating profile uses a maximum temperature that is from greater than 800° C. to 1300° C.

An embodiment 14 is according to any of embodiments 1-13, wherein a source of gaseous hydrocarbons is provided during the thermal treatment to provide a reinforced biochar composite product.

An embodiment 15 is according to any of embodiments 1-14, wherein the method further comprises exposing the biochar composite product to an activation agent to provide an activated biochar composite product.

An embodiment 16 is a biochar composite product comprising a plurality of porous, carbonaceous particles and a solid, porous, covalently bound carbon matrix on surfaces of particles in the plurality such that neighboring particles are adhered together to form the biochar composite product as a solid, unitary, monolithic, free-standing structure.

An embodiment 17 is according to embodiment 16, wherein particles in the plurality of porous, carbonaceous particles have elongated, rectangular shapes with ragged edges and an average largest dimension in a range of from 1 mm to 500 mm.

An embodiment 18 is a method of using the biochar composite product of any of embodiments 16-17, the method comprising passing a fluid medium comprising an impurity through the biochar composite product, wherein after passage, the fluid medium has a decreased amount of the impurity as compared to prior to passage.

An embodiment 19 is according to embodiment 18, wherein the fluid medium is wastewater and the impurity is a metal, a PFAS, or both

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A shows biochar yield versus pyrolysis temperature at 0 and 1 wt % NaOH loadings. FIG. 1B shows biochar yield versus NaOH loading at pyrolysis temperatures of 450° C. and 550° C. FIG. 1C shows the influence of pyrolysis temperature on the pH of biochar produced from wood pine particles treated with 0 wt % NaOH and 1 wt % NaOH. FIG. 1D shows pH variation of biochar at a pyrolysis temperature of 550° C. using various NaOH loadings of 0, 0.2, 0.5, 1, and 2 wt %.

FIGS. 2A-2F show Thermal Gravimetric Analysis (TGA)/Differential scanning calorimetry (DSC) results from various binders: corn starch (FIG. 2A), citric acid (FIG. 2B), microcellulose (FIG. 2C), carboxymethyl cellulose (CMC) (FIG. 2D), tannin (FIG. 2E), and kraft lignin (FIG. 2F).

FIGS. 3A-3F show SEM images of various binders after thermal treatment: corn starch at 320° C. (FIG. 3A), microcellulose at 320° C. (FIG. 3B), citric acid at 240° C. (FIG. 3C), carboxymethyl cellulose at 275° C. (FIG. 3D), tannin at 200° C. (FIG. 3E), and kraft lignin at 240° C. (FIG. 3F).

FIG. 4 shows a SEM image of a biochar composite material fabricated using a 1:1 mass ratio of biochar:(kraft lignin) and low temperature thermal treatment (240° C.).

FIG. 5 shows a SEM image of a biochar composite material fabricated using a 7:3 mass ratio of biochar:tannin and medium temperature thermal treatment (450° C.).

FIG. 6 shows a SEM image of a biochar composite material fabricated using a 7:3 mass ratio of biochar:starch and high temperature thermal treatment (1000° C.).

FIG. 7 shows a SEM image of a biochar composite material fabricated using a 7:3 mass ratio of biochar:tannin and high temperature thermal treatment (1000° C.).

FIG. 8 is a schematic of a flow chart depicting illustrative methods to fabricate the present biochar composite materials.

### DETAILED DESCRIPTION

Provided are biochar composite materials, methods of fabricating the materials, and methods of using the materials. The biochar composite materials are also encompassed by the present disclosure. The biochar composite materials are fabricated from precursor compositions comprising (or consisting of) biochar and a binder. The precursor compositions are thermally treated according to various heating profiles which are further described in detail below to provide the biochar composite materials.

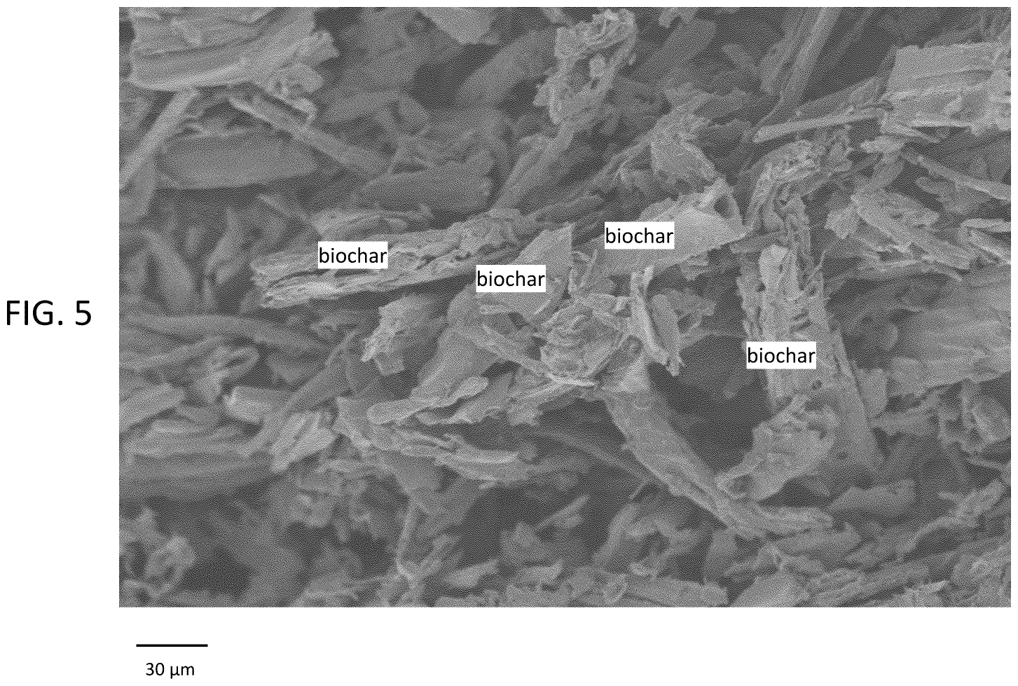

The term “biochar” as used herein refers to biomass that has been partially (i.e., not completely) decomposed to convert the biomass to carbon. The specific chemical and physical properties of the biochar depend upon the biomass source and the decomposition process used to provide the biochar. However, “biochar” refers to a plurality of discrete porous particles. The porous particles of the biochar generally do not adhere to one another such that the biochar is in the form of a free-flowing powder. The porous particles are composed primarily of carbon (e.g., at least 60%, at least 70%, at least 80%, at least 60% carbon or a range between any of these values). The carbon is generally in the form of a network of covalently bound aromatic and/or heterocyclic groups. Functional groups, e.g., carbonyl (CO), carboxyl (C═O), and hydroxyl (OH) groups are generally incorporated throughout. The porous particles are generally irregularly shaped and have average sizes (largest dimension) which are generally less than 5 mm and may range, e.g., from 1 mm to 1 mm, from 1 mm to 500 mm, and from 1 mm to 100 mm. Regarding these irregular shapes, this includes the plurality of porous particles having elongated (aspect ratio>1), rectangular shapes with ragged edges as shown in FIGS. 5-7. By “porous particles,” it is meant that the individual particles have pores distributed throughout. Additional pores may be defined as spaces between neighboring particles in the plurality of porous particles.

The biomass from which the biochar is derived refers to carbon rich materials derived from a living organism, generally plants. The biochar may be derived from a woody biomass (e.g., wood chips from various tree species) or an agricultural waste biomass (e.g., corn stalks, rice hulls, wheat straws). However, other biomass sources may be used. Regarding the decomposition process to convert the biomass to biochar, the biochar may be derived from a pyrolysis process conducted under certain conditions, including under limited amounts (or free of) oxygen, a particular pyrolysis temperature, and pyrolysis atmosphere. For example, in embodiments, the pyrolysis process is an atmospheric pyrolysis process conducted at atmospheric pressure under an inert, non-oxidizing atmosphere (e.g., N₂). In embodiments, the pyrolysis process is a vacuum pyrolysis process conducted under vacuum conditions (i.e., less than 1 atm) and an inert, non-oxidizing atmosphere. In either process, the pyrolysis temperature may be in a range of from 400° C. to 800° C. This includes the pyrolysis temperatures used in the Examples A1-A4 and B1-B2 below and ranges between any of those values. As demonstrated in these Examples, higher pyrolysis temperatures and vacuum pyrolysis are useful to increase the porosity and surface area of the biochar. The conditions of the pyrolysis process also refer to a pyrolysis time and a heating rate, illustrative values of which are provided in the Examples below. Other decomposition processes may be used to provide the biochar, e.g., hydrothermal carbonization, torrefaction, etc.

The biochar may be unmodified or modified. “Modified biochar” refers to the use of additional processing step(s) that physically or chemically modify the biochar. Regarding physical modification, this includes altering physical features of the biochar, e.g., porosity and surface area without altering the chemical composition of the biochar. Chemical modification includes altering chemical features of the biochar, e.g., incorporating additional chemical elements, groups, etc. into the biochar. Although the additional processing step(s) may vary depending upon the type of modification, the additional processing involves exposure to an activation agent under activation conditions to provide the modified biochar. The additional processing step(s) may be carried out after formation of the biochar (Examples A1, A2, B2) or concurrently with formation of the biochar (Example A3, A4). In other embodiments, the biomass itself may be subjected to additional processing and then used to form the modified biochar (Example B1). “Unmodified biochar” is used in reference to biochar provided by the methods described in the paragraph immediately above without using any of these additional processing steps to achieve physical/chemical modification.

An illustrative physical modification step is steam activation comprising exposing biochar to steam (activation agent) at an activation temperature for an activation time (Examples A1-A2). Illustrative activation temperatures, times, and other activation conditions are provided in the Examples below. Another illustrative physical modification step is CO₂ activation comprising exposing biomass to CO₂ (activation agent) during pyrolysis (Examples A3-A4). As demonstrated in the Examples, below, steam and CO₂ activation, particularly using vacuum pyrolysis, is useful to increase the porosity and surface area of the modified biochar.

An illustrative chemical modification step involves exposure to an alkaline solution comprising a base (activation agent), such as NaOH, KOH, etc. (Example B1). This includes exposing the biomass to the alkaline solution followed by forming modified biochar from the modified biomass. Illustrative activation conditions (e.g., amount of base, temperature, time, etc.) are provided in the Examples, below. Regarding the amount of base, the amount may be measured as a weight % of base as compared to total amount of base and biomass used to provide the modified biochar. As demonstrated in the Examples, below, use of a base as an activation agent increases the number of oxygen-containing functional groups in the biochar while also increasing porosity/surface area. Another illustrative chemical modification step involves exposure to a metal-containing solution comprising a metal precursor (activation agent), such as a metal salt. (Example B2). This includes exposing the biochar to the metal-containing solution to incorporate metal of the metal precursor into the biochar to form the modified biochar. Illustrative activation conditions (e.g., amount of metal salt, temperature, time, etc.) are provided in the Examples, below. Use of a metal salt as the activation agent incorporates metal ions into the biochar. The metal of the metal-containing solution may be a transition metal (e.g., Fe, Ni, Cu, Co, Mo, Mn, W, etc.), an alkaline earth metal (e.g., Ca, Mg, Sr, etc.), an alkali earth metal (Li, Na, K, Cs, etc.) or combinations thereof.

Other chemical modification steps involving exposure to other activation agents may be used, e.g., air, acids (H₂SO₄, H₃PO₄, HNO₃), oxidants (e.g., H₂O₂, KMnO₄), etc.

The precursor composition further comprises a binder. The binder is a material or chemical compound capable of adhering (e.g., via covalent and/or non-covalent bonds) to the selected biochar and capable of forming a solid, porous, carbonaceous matrix upon thermal treatment above a threshold temperature. The term “carbonaceous” is used to indicate that this matrix is composed primarily of a covalently bound carbon network that extends in three-dimensional (3D) space (i.e., a 3D network) although other elements and functional groups may be present. The material/chemical compound of the binder is generally one found in nature rather than one obtainable only via synthesis. Thus, the term “natural” may be used to characterize the binder. Carbon rich biopolymers, polysaccharides, and biomolecules may be used as the binder, e.g., lignin, cellulose (nanocellulose, microcellulose, carboxymethyl cellulose), soy protein, starch, tannin, microalgae. Smaller chemical compounds may be used as the binder such as citric acid, saccharides, and lipids. Carbon rich biomaterials may be used as the binder, e.g., bio-oil, tar, pitch, black liquor, and biorefinery solid residue. Although some binders may be a component of the biomass used to provide the biochar, the biochar and the biomass in the precursor compositions are distinct components that are combined to form the precursor compositions. In embodiments, the binder is not lignin. In embodiments, the binder is selected from the group consisting of starch, tannin, and carboxymethyl cellulose, biorefinery solid residue, and bio-oil. Bio-oil may refer to a byproduct of the decomposition process to provide the biochar.

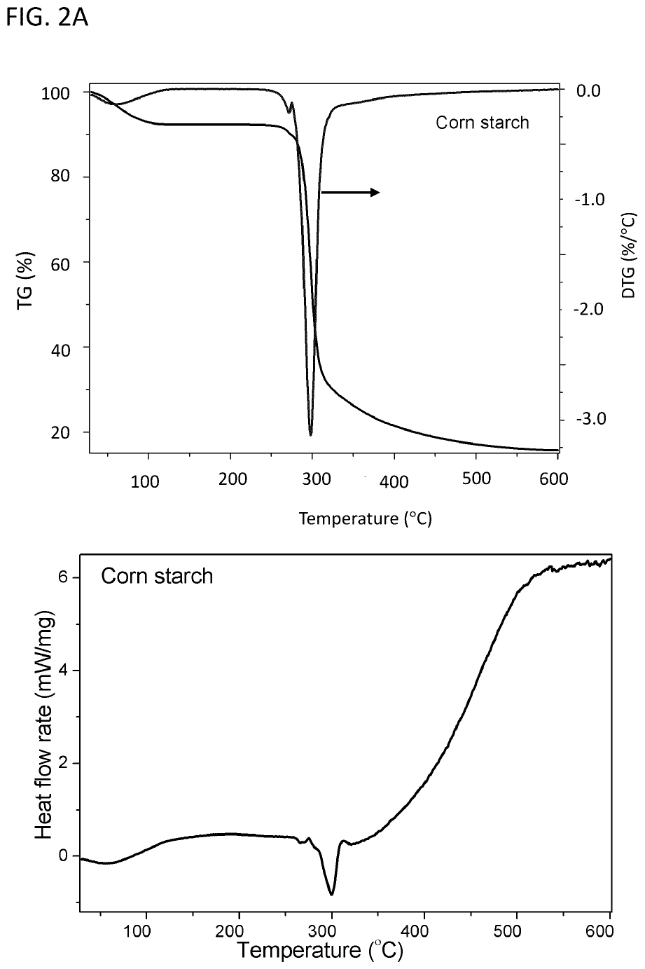

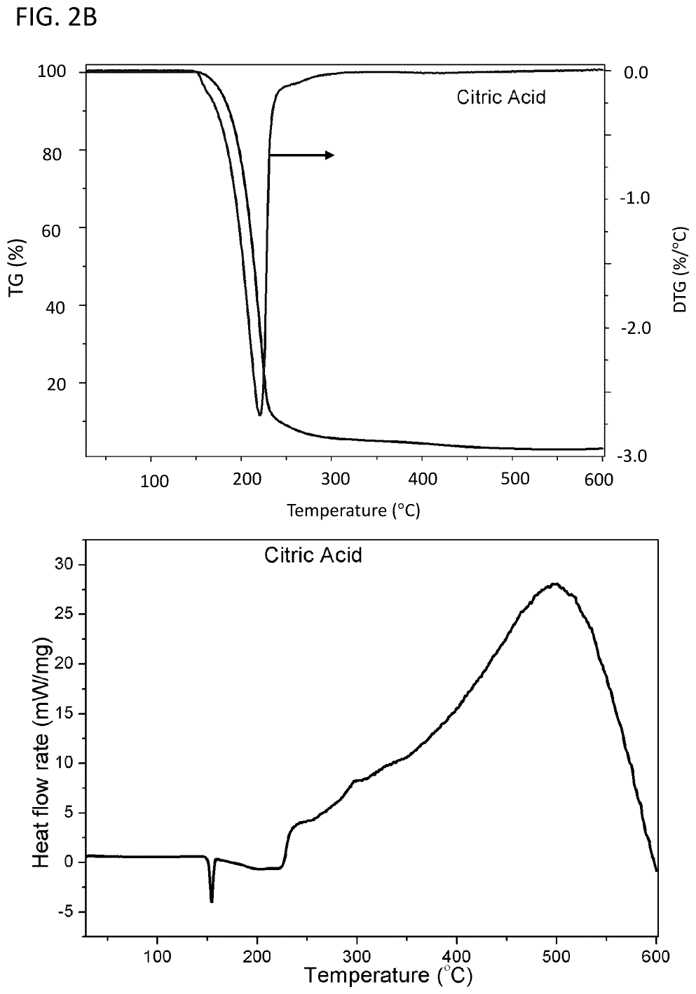

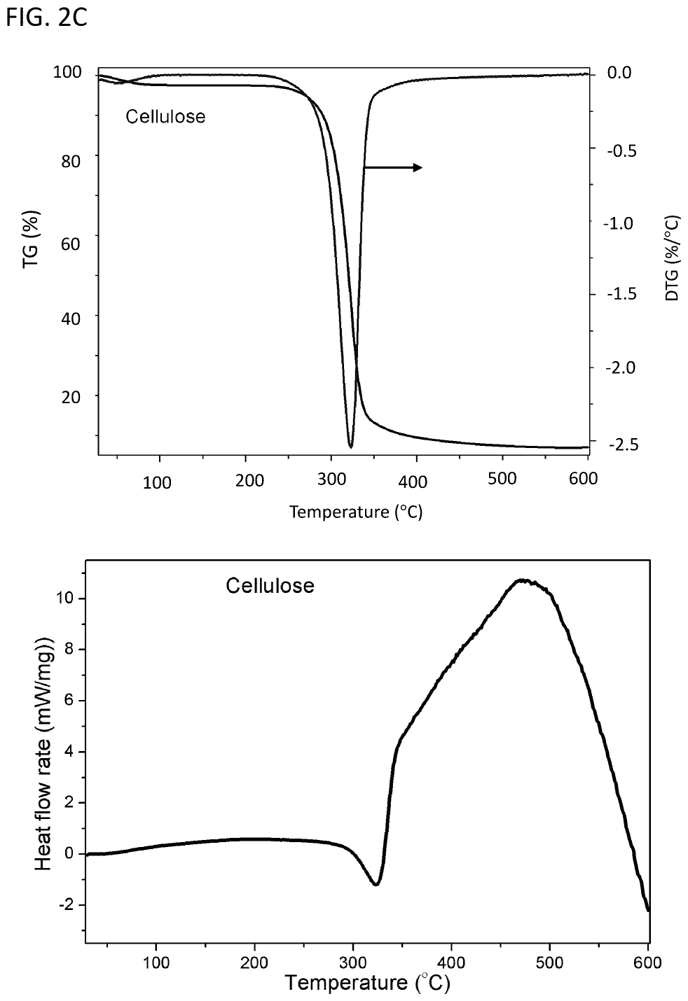

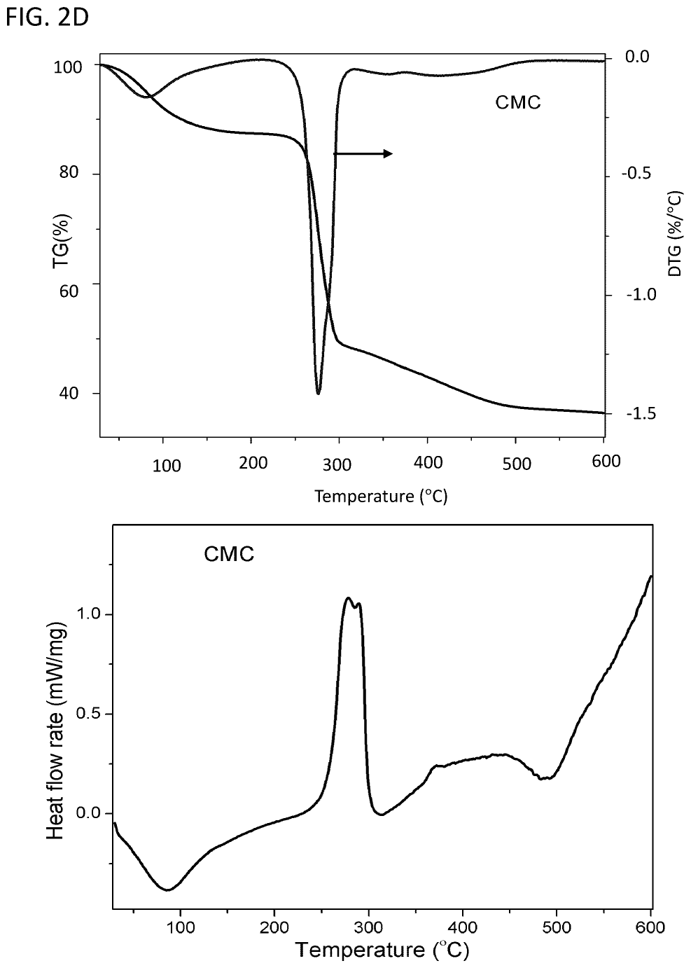

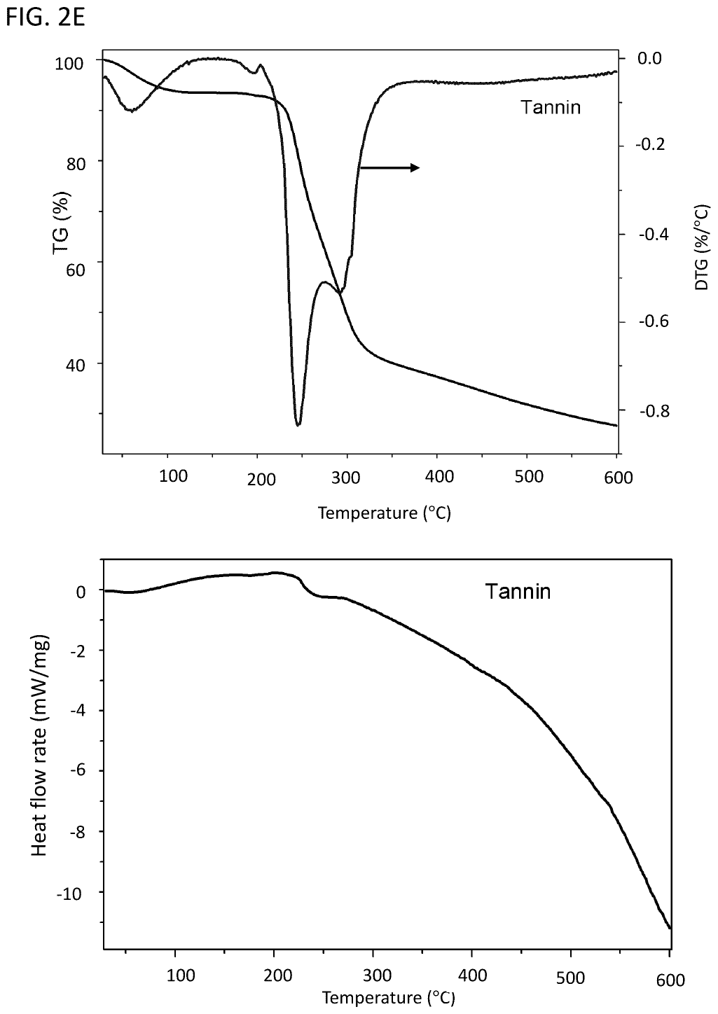

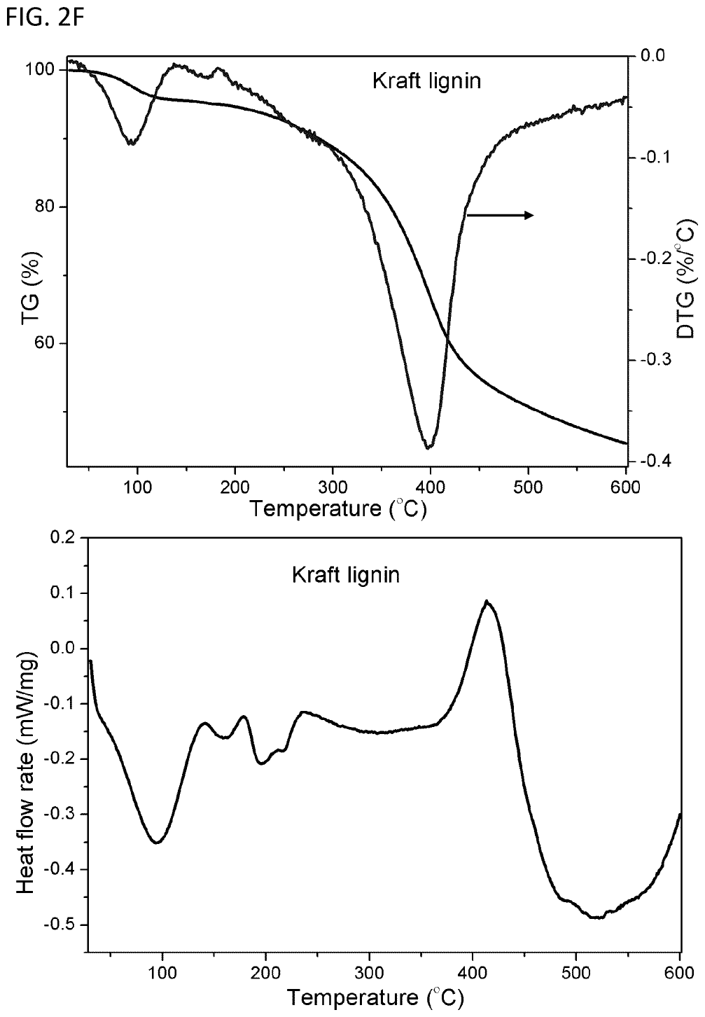

Regarding thermal treatment of the binder in the precursor composition, at room temperature, the binder is generally in the form of a plurality of discrete particles as in a free-flowing powder, but the thermal treatment, i.e., heating the binder to an elevated temperature above room temperature, softens or melts the binder, allowing it to flow and coat surfaces of the biochar. Above the binder's decomposition temperature (the threshold temperature), decomposition reactions occur which lead to pore formation, carbon-carbon covalent bonding, and an increase in carbon content to form the solid, porous, carbonaceous matrix. Thermogravimetric analysis (TGA) and differential scanning calorimetry (DSC) as described in the Examples below may be used to determine a binder's threshold temperature. (See also FIGS. 2A-2F and Table 3, below). The thermal treatment to convert the binder to the solid, porous, carbonaceous matrix may be part of the thermal treatment according to a heating profile that ultimately provides the biochar composite materials as further described below.

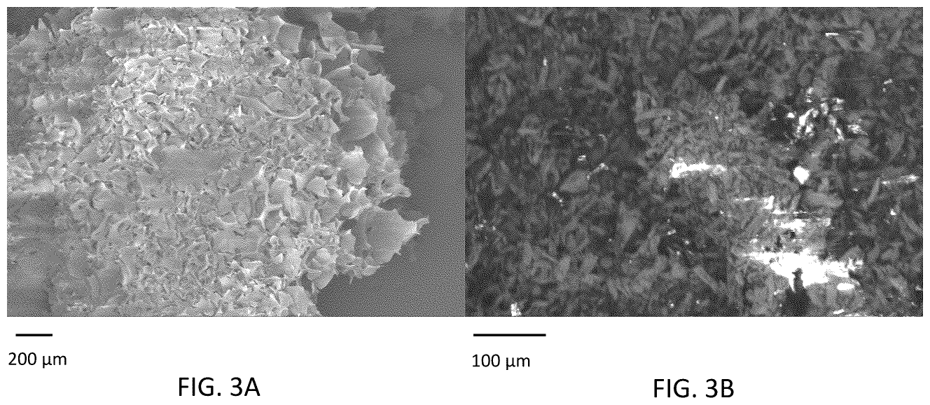

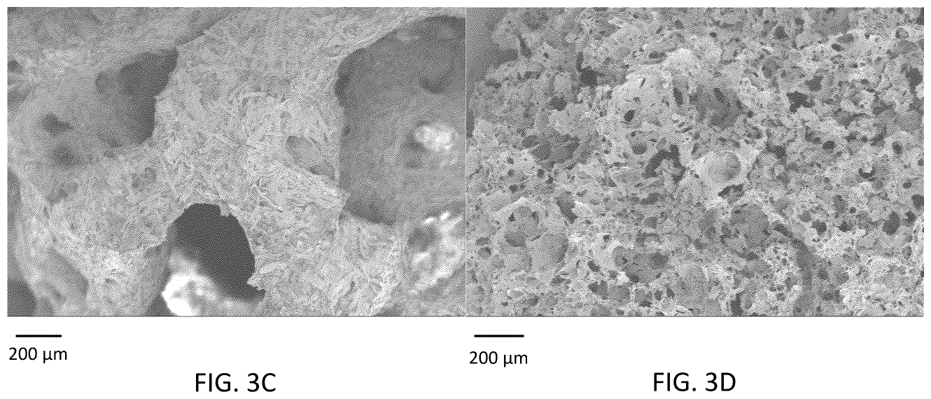

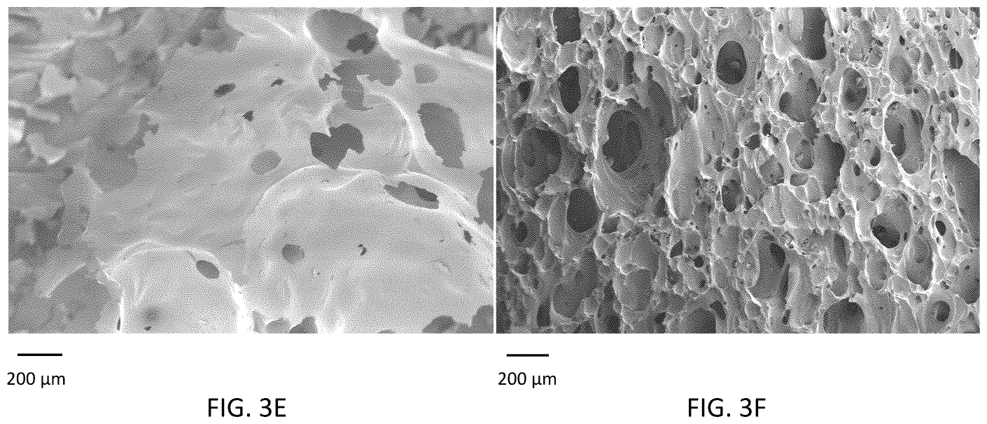

The physical (e.g., pore size, shape, distribution) and chemical properties (e.g., chemical composition) of the solid, porous, carbonaceous matrix depends upon the selected binder and the conditions of the thermal treatment. However, regarding physical properties, the differences in this matrix after thermal treatment may be evidenced by scanning electron microscopy (SEM) images such as those shown in FIGS. 3A-3F. As illustrated in these SEM images, different binders produce distinctly different solid, porous, carbonaceous matrices. X-ray Diffraction (XRD) and energy-dispersive X-ray spectroscopy (EDS) may be used to determine the chemical composition of the matrix.

The precursor composition may include various amounts of the biochar and the binder therein. However, generally more biochar is used than binder. In embodiments, the mass ratio of biochar:binder is in a range of from 5:1 to 1.5:1 and from 4:1 to 1.5:1. This includes mass ratios of 4:1, 3:1, 2:1, and ranges between any of these values. The particular mass ratio may be selected depending upon application.

A single type of biochar (i.e., same biomass source, same decomposition process) or different types of biochar may be used. A single type of binder (i.e., same chemical composition) or different types of binders may be used.

The precursor composition may include an additive in addition to the biochar and the binder. However, in embodiments, no additive is included. In embodiments, additives which are excluded are one or more of the following: isocyanates, silanes, catalysts, surfactants, baking powder, azodicarbonamide, titanium hydride, glycol, glycerol, crude glycerol, epoxidized soybean oil, stearic acid, sodium stearate, calcium stearate, mineral oil. Synthetic polymers may be excluded such as one or more of polypropylene (PP), poly(methyl methacrylate) (PMMA), acrylonitrile butadiene styrene (ABS), nylon, polybenzimidazole (PBI), polycarbonate (PC), polyether sulfone (PES), polyoxymethylene (POM), polyether ether ketone (PEEK), polyethylene terephthalate (PETE), polyetherimide (PEI), polyethylene (PE), polymethylpentene (PMP), polybutene-1, polyphenylene oxide (PPO), polyphenylene sulfide (PPS), polystyrene (PS), polyvinyl chloride (PVC), Teflon or polytetrafluoroethylene (PTFE), polyacrylonitrile (PAN), poly(ethylene glycol), and poly(propylene glycol).

In embodiments, the precursor composition consists of biochar and binder. A single type of biochar or different types of biochar may be used. A single type of binder or different types of binders may be used. In any of these embodiments, the presence of a small amount of water may be present. If modified biochar is used, these embodiments encompass the presence of element(s) from the modification process used.

As noted above, in embodiments, the precursor composition includes modified biochar. In embodiments, modified biochar may be provided by subjecting the precursor composition to physical or chemical modification as described above. This is illustrated by reference to Example C6 in which sulfur powder was included in a precursor composition comprising binder and NaOH-modified biochar.

Due to the nature of the biochar and the binder, the precursor composition is also generally in the form of a free-flowing powder. The thermal treatment, further described below, converts this powder into a solid, unitary, monolithic, free-standing biochar composite product. The shape and dimensions of this biochar composite product are not particularly limited, but rather depend upon the desired application. To fabricate the biochar composite product, the precursor composition may be placed into a mold having an internal cavity, the shape and dimensions of which correspond to those of the desired product.

Thermal treatment of the precursor composition refers to heating the precursor composition according to a heating profile. The heating profile refers to the temperature being used as a function of time. The heating profile further refers to the heating rate(s), the overall heating time, and the presence of any isothermal holds that may be used during the thermal treatment. The thermal treatment may involve relatively low temperatures in which the maximum temperature used is greater than the binder's threshold temperature, but no greater than 320° C. This includes from 150° C. to 300° C., from 175° C. to 275° C., and from 200° C. to 250° C. The thermal treatment may involve medium temperatures in which the maximum temperature used is 350° C. or greater, but less than 700° C. or 800° C. This includes from 375° C. to 600° C., from 400° C. to 550° C., and from 425° C. to 525° C. The thermal treatment may involve high temperatures in which the maximum temperature used is from 700° C. to 1300° C. or greater than 800° C. to 1300° C. This includes from greater than 800° C. to 1100° C. and from 850° C. to 1000° C. Illustrative heating profiles are provided in the Examples, below. Each of these temperature regimes provides a biochar composite product having different characteristics due to the different temperatures being used. However, as the temperature increases, the carbon content of the biochar composite product increases, including the amount of hard carbon (sp³ hybridized carbon) therein as compared to the amount of soft carbon (sp² hybridized carbon). Other conditions of the thermal treatment include parameters such as the atmosphere being used (which may be an inert, non-oxidizing atmosphere), pressure of the atmosphere being used (which may be atmospheric pressure or a vacuum), and use of a mechanical pressure (e.g., from 1 psig to 1000 psig or 1 psig to 100 psig) on the precursor composition. Illustrative values of these parameters are provided in the Examples, below.

The Examples below describe use of various thermal treatments on various precursor compositions to provide various biochar composite materials, including those making use of low temperatures (Examples C1-C6 and C9), medium temperatures (Examples C7-C9), and high temperatures (Examples C11-C17).

In embodiments, a source of gaseous hydrocarbons is provided during the thermal treatment as described in U.S. Pat. No. 11,618,719, which is hereby incorporated by reference in its entirety. Biochar composite products fabricated using this embodiment may be referred to as reinforced biochar composite products. (See Example C17.) The reinforcement is in the form of additional carbon on surfaces of and/or within the biochar composite product. This carbon may be in the form of a coating, carbon nanofibers extending from the surface of the biochar composite product, and/or entangled carbon microfibers within the pores of the biochar composite product.

Distinct from any mechanical pressure being used during thermal treatment, in embodiments, a separate compression step may be carried out prior to the thermal treatment. Such a compression step comprises subjecting the precursor composition to pressure, e.g., mechanical pressure, for a period of time. Illustrative compression steps are provided in the Examples, below. (Example C14.)

As noted above, modified biochar may be used to provide the biochar composite products. Alternatively, or in addition, a separate activation step may be carried out. Such an activation step comprises subjecting the fabricated biochar composite product to any of the physical and/or chemical modification steps described above, including exposure to an activation agent under activation conditions. Biochar composite products fabricated using this embodiment may be referred to as activated biochar composite products (See Example C10.)

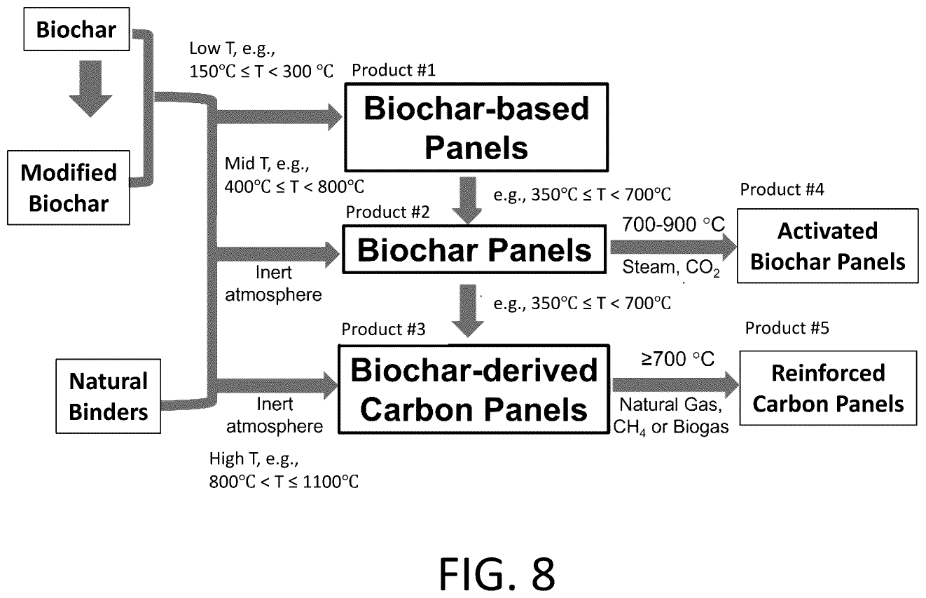

FIG. 8 is a schematic of a flow chart depicting illustrative methods to fabricate the present biochar composite materials. In this flow chart, the biochar composite products are in the form of a panel.

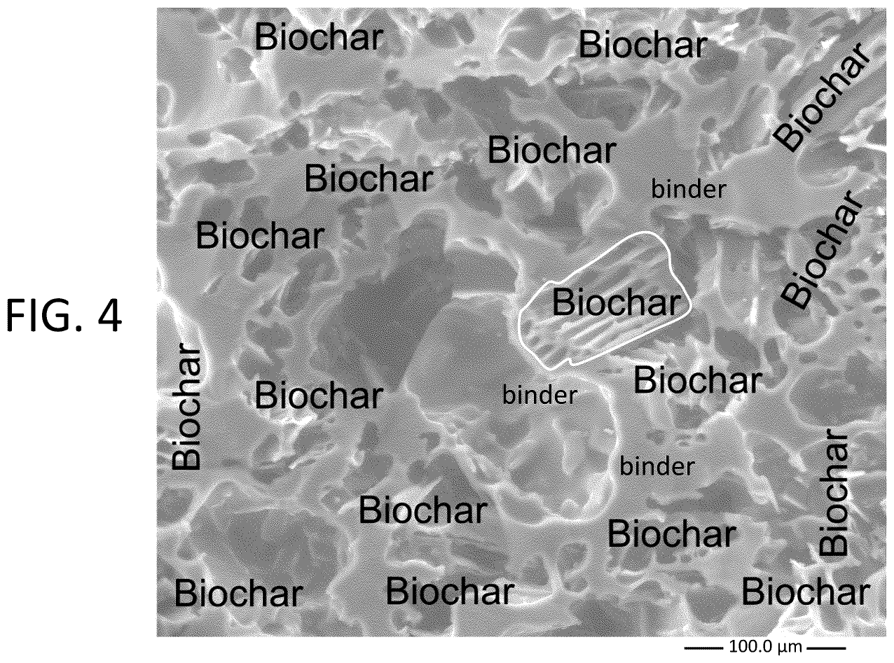

Also encompassed by the present disclosure are the biochar composite products fabricated using the present methods. The biochar composite products comprise (or consist of) a plurality of biochar particles and a solid, porous, matrix of covalently bound carbon distributed on surfaces of biochar particles such that neighboring biochar particles are adhered to one another via this matrix. (See FIGS. 4-7). The greater the amounts of binder used relative to biochar, the matrix begins to fill spaces between individual biochar particles such that the particles become embedded therein. (See FIG. 4.) As noted above, although the precursor composition is generally in the form of a free-flowing powder, the biochar composite product is a solid, unitary, monolithic, free-standing structure having variable shapes and dimensions depending upon application. However, as shown in the SEM images of FIGS. 5-7, the individual, discrete biochar particles are still present and identifiable. This distinguishes carbon foam products formed exclusively of lignin, including those described in U.S. Pat. Nos. 11,142,458 and 11,618,719, or lignin and a thermoplastic polymer as in U.S. Pat. No. 11,261,308.

The chemical and other physical properties of the biochar composite product depend upon the selected biochar and binder, and particular thermal treatment used. However, regarding chemical composition, for lower temperature thermal treatments, the chemical composition is more similar to that of the biochar and binder prior to the thermal treatment. Thus, biochar composite products formed from different biochars and binders are distinguished based on their chemical composition (which may be determined using the techniques described herein). For higher temperature thermal treatments, as noted above, the carbon content can increase as compared to the biochar and binder prior to the thermal treatment. Regardless of thermal treatment, if modified biochar is used, additional elements such as oxygen or metal(s) may be incorporated within the biochar composite product. Physical properties, including bulk density, porosity, compressive strength, and thermal conductivity may be tuned via selection of biochar, binder, and thermal treatment. Illustrative values are provided in the Examples, below.

The biochar composite products are characterized by a broad distribution of pore sizes. This includes the biochar composite products having pores having a largest cross-sectional dimension in a range of from 0.1 nm to several millimeters. That is, the biochar composite products comprise macropores (>50 nm), mesopores (2-50 nm), and micropores (<2 nm). As a result, the surface area of the biochar composite products span a broad range, e.g., from 10 to 2000 m²/g. The biochar composite products may also be characterized by a pH value, which may span a broad range, e.g., from 2 to 13.

After fabrication according to the present methods, any of the disclosed biochar composite products may be used as is or may be machined and/or combined with other material(s) for use as a desired article of manufacture or in a desired device. Such articles of manufacture and devices are also encompassed by the present disclosure.

An illustrative application is using any of the disclosed biochar composite products to remove an impurity from a fluid medium. The impurity may be a metal, including a heavy metal (e.g., Pb, Cd, Hg, As, Cr, etc.). Other impurity metals may be transitions metals such as Ni. The impurity may be a perfluoroalkyl or polyfluoroalkyl substance (PFAS). The fluid medium may be a liquid such as water, including wastewater. In these applications, the biochar composite products serve as a filter or adsorbent through which the fluid medium may flow due to the porous nature of the biochar composite products. Upon contact with the fluid medium, any impurities therein become absorbed by the biochar composite product and thus, removed from the fluid medium. The Examples, below, illustrate this application and demonstrate that illustrative biochar composite products have surprisingly high absorption efficiencies for heavy metals and PFAS, including greater than 90%, greater than a 95%, greater than 98%, and greater than 99%. (See Examples D1-D3.)

Other applications for the present biochar composite products include any of those in which porous carbonaceous materials find use. This includes applications in which fire-resistant light-weight materials are used. This further includes use in insulating panels, core of SIP panels, support for catalysts, sound proofing, radio frequency absorption, electrodes for energy storage devices, electrical conduction panels, etc.

Methods of using any of the disclosed biochar composite products in any of the applications described above are encompassed by the present disclosure.

### EXAMPLES

### Examples A1-A4: Physically Modified Biochar

Several samples of modified biochar were prepared using physical modification. To produce high surface area and porous biochar, it is desirable to avoid the formation of closed pores during the pyrolysis process. Several strategies were used to eliminate or reduce formation of closed pores. The first strategy was to concurrently feed activation gases (e.g., CO₂ or H₂O) with inert gases during the pyrolysis process. In this method, volatiles are reformed to CO and H₂ by CO₂ or H₂O at high temperature, which prevents the blocking of pore openings by reducing thermal cracking. A second strategy used vacuum pyrolysis to reduce carbon deposition in the pores of the biochar. Volatiles diffuse rapidly out of the inner pores of biochar under vacuum pyrolysis leading to a much shorter residence time as compared to atmospheric pyrolysis. Therefore, secondary reactions of these volatiles in the pores of the biochar are limited, and deposited carbon in pores is decreased considerably. Wood biochar from vacuum pyrolysis is more reactive to CO₂ oxidation than those produced by atmospheric pyrolysis. Biochar from vacuum pyrolysis also contains more open pores and is more easily activated by CO₂ and H₂O. As demonstrated below, it was found that under the same activation conditions, vacuum pyrolytic processes yields biochar with a higher specific surface area as compared to biochar from atmospheric pyrolysis. It was also found that biochar from vacuum pyrolysis reacts faster with steam as compared to biochar from atmospheric pyrolysis.

### Example A1 Physically Modified Biochar Via Atmospheric Pyrolysis (AP) and Steam Activation

The pyrolysis and activation processes were performed using a home-built fixed bed tubular reactor system (4-in O.D., alumina ceramic) which was placed in an electrical furnace. A mechanical vacuum pump was connected to the outlet of the reactor system. The heating rate, pyrolysis temperature, and heating time were programmed using the control panel. For each pyrolysis run, 800 grams of wood pine waste (biomass) were packed in the middle of the tubular reactor. A nitrogen flow was first introduced into the reactor at a flow rate of 500 mL/min for 30 min. The reactor was heated at a rate of 10° C./min to a pyrolysis temperature, and kept at that temperature for 60 min. Pyrolysis of the wood pine waste samples was accomplished at five temperatures (400° C., 500° C., 600° C., 700° C., and 800° C.). The biochar from the pyrolysis process was either taken out of the reactor and denoted as BC-AP (unmodified) or further activated using steam. The activation process was performed in the same reactor system. For the activation process, the activation temperature was selected as 800° C. The reactor was heated from room temperature to the activation temperature and held for 60 min. Nitrogen (100 mL/min) and steam (1000 mL/min) were co-fed into the reactor during the activation process. The products prepared in this process are referred to as BC-AP-H₂O samples.

### Example A2 Physically Modified Biochar Via Vacuum Pyrolysis (VP) and Steam Activation

Vacuum pyrolysis was carried out in the same reaction system as atmospheric pyrolysis (Example A1). For each vacuum pyrolysis run, 800 g of wood pine waste was placed in a tubular reactor. The air in the reactor was evacuated by the vacuum pump before the pyrolysis process and a steady pressure of about 0.5 atm vacuum was attained by flowing 500 ml/min nitrogen. The reactor was heated at a specific rate from room temperature to a selected pyrolysis temperature (see Example A1) and held for 60 min. After pyrolysis, the reactor was naturally cooled down to room temperature under the same vacuum. The biochar from the vacuum pyrolysis process was either removed from the reactor and denoted as BC-VP samples or further activated using steam at 800° C. for 60 min. During the steam activation process, nitrogen (500 mL/min) and steam (1200 mL/min) were co-fed into the reactor. The products prepared in this process are referred to as BC—VP—H₂O samples.

### Example A3 Physically Modified Biochar Via Atmospheric CO₂ Gasification (AG-CO₂)

The atmospheric CO₂ gasification process was performed using the same system as the atmospheric pyrolysis process (Examples A1, A2). For each CO₂ gasification run, 800 g of wood pine waste was packed in the middle of the tubular reactor. Ar (500 mL/min) and CO₂ (1200 mL/min) were first introduced into the reactor for 30 min. The reactor was then heated at a rate of 10° C./min to a selected pyrolysis temperature (see Example A1) and kept at this temperature for 60 min. After CO₂ gasification, the furnace was cooled down to room temperature while under the Ar/CO₂ atmosphere. The biochar from the CO₂ gasification process are referred to as BC-AG-CO₂ samples.

### Example A4 Physically Modified Biochar Via Vacuum CO₂ Gasification (VG-CO₂)

The vacuum CO₂ gasification (VG-CO₂) process was carried out in the same reaction system as atmospheric pyrolysis (Examples A1, A2). For each VG-CO₂ run, 800 g of wood pine waste was placed in the reactor. Air in the reactor was evacuated by vacuum pump before the pyrolysis process and a steady pressure of about 0.5 atm vacuum was attained by flowing 500 mL/min nitrogen and 1000 mL/min CO₂. The sample in reactor was vacuum gasified with flowing CO₂ at a heating rate of 10° C./min to a to a selected pyrolysis temperature (see Example A1) and kept at this temperature for 60 min. The biochar from the VG-CO₂ process are referred to as BC-VG-CO₂ samples.

The effect of pyrolysis temperature on the biochar surface area is shown in Table 1.

TABLE 1
Effect of pyrolysis temperature (400-800° C.) on the surface area of biochars.

| | Surface Area (m²/g) | | | | | |
|---|---|---|---|---|---|---|
| Temperature | BC-AP | BC-AG- | BC-VP | BC-AP- | BC-VP- | BC-VG- |
| (° C.) | (unmodified) | CO₂ | (unmodified) | H₂O | H₂O | CO₂ |
| 400 | 5.6 | 7.5 | 25.9 | 587.3 | 705.3 | 78.5 |
| 500 | 7.8 | 23.6 | 136.2 | 605.9 | 755.8 | 207.6 |
| 600 | 10.9 | 115.8 | 183.1 | 629.3 | 769.3 | 452.7 |
| 700 | 12.5 | 396 | 215.6 | 715.4 | 836.5 | 786.5 |
| 800 | 15.3 | 678 | 228.3 | 803.5 | 845.8 | 855.9 |

### Examples B1-B2: Chemically Modified Biochar

Several samples of modified biochar were prepared using chemical modification techniques.

### Example B1 Modified Biochar with Tunable pH Values

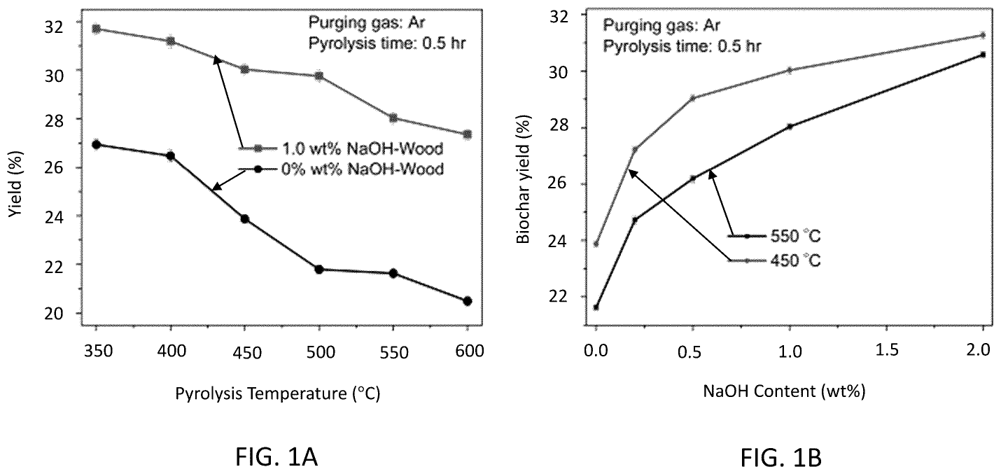

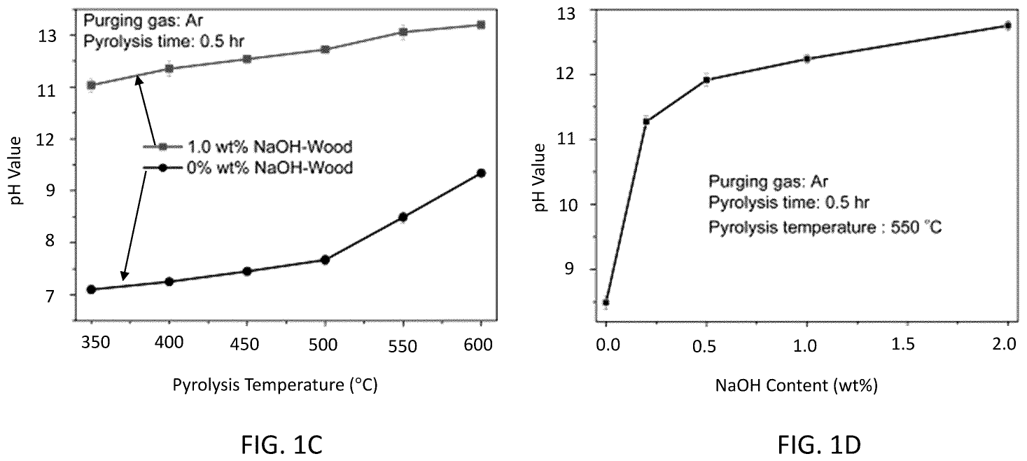

Biomass (wood pine particles) was first pretreated with alkaline solution. This involved mixing NaOH solutions of varying concentrations with the wood pine particles. A liquid-to-solid mass ratio of 2.44:1 was used, based on preliminary tests. The mixture was stirred continuously for 30 min, followed by intermittent stirring over the next 2 hours. To facilitate deeper penetration of the NaOH solution into the wood pine particles, a vacuum was applied to the mixture for 10 min. The mixture was then stored in the dark for a total duration of 24 hours, starting from the initial mixing. The mixture was subsequently air dried for 24 hours, followed by oven drying at 105° C. for another 24 hours. This resulted in the wood pine particles having various NaOH loadings, including 0.2, 0.5, 1.0, and 2.0 wt %. The pretreated biomass feedstock was meticulously stored in air-tight containers to preserve its quality. Next, biochar was prepared from the pretreated biomass feedstock using an atmospheric pyrolysis process (Example A1). Pyrolysis experiments were carried out in a fixed-bed tubular (4-inch o.d.) reactor under 99.99% Argon flow of 0.2 SLPM, with a heating rate of 20° C./min. The pyrolysis temperatures used included 350° C., 400° C., 450° C., 500° C., 550° C. and 600° C. FIG. 1 shows the effects of pyrolysis temperature and NaOH levels on the yield and pH values of biochar.

Table 2 presents a comprehensive overview of the physicochemical characterization of biochar (BC) produced with different NaOH loadings after pyrolysis at 450° C. The BET surface area ranged from 288.1 to 248.0 m²g⁻¹ as the NaOH loading increased from 0 weight % to 2 weight %. Simultaneously, the average pore diameter increased, indicating changes in microporosity which could be attributed to NaOH's role in broadening existing pores. Lastly, the total pore volume ranged from 0.076 to 0.069 cm³g⁻¹ (which is important for contaminant uptake). As the total pore volume does not significantly change with NaOH loading, there appears to be a threshold of porosity enhancement using NaOH treatment. Collectively, these data provide insights into the impact of NaOH treatment on the development of BC's structural properties, which is crucial for its application in heavy metal removal.

TABLE 2
Physicochemical properties of NaOH-treated biochar
samples (450° C.) including BET surface area,
average pore diameter, and total pore volume.

| | BET Surface | Average pore | Pore Volume |
|---|---|---|---|
| Biochar | Area (m²g⁻¹) | diameter (Å) | (cm³g⁻¹) |
| 0% NaOH-BC | 288.1 | 10.600 | 0.076 |
| 0.2% NaOH-BC | 276.1 | 10.938 | 0.075 |
| 0.5% NaOH-BC | 271.0 | 10.786 | 0.073 |
| 1% NaOH-BC | 240.8 | 11.007 | 0.070 |
| 2% NaOH-BC | 248.0 | 11.105 | 0.069 |

### Example B2 Modified Biochar with Transition Metals

Biochar samples modified with transition metals were prepared using an impregnation method. The biochar used was prepared using fast pyrolysis.

Preparation of iron promoted biochar: Iron-promoted wood pine biochar was prepared by an impregnation method. Twenty grams of Ferric chloride [FeCl₃, Sigma-Aldrich]) was added to 200 mL of DI water first, followed by the addition of the biochar to the iron chloride solution and then the solution was stirred for 30 minutes. The mixture was kept at room temperature for 24 h, and then transferred to an oven where it was dried at 110° C. for one day.

Preparation of nickel promoted biochar: Ni promoted wood pine biochar was prepared by an impregnation method. First, 20 g nickel (II) chloride [NiCl₂, Sigma-Aldrich]) was added to 100 mL DI water. The biochar was added to the solution of nickel nitrate and stirred for 30 minutes. The mixture was kept at room temperature for 24 h, then transferred to an oven where it was dried at 110° C. for one day.

Preparation of cobalt promoted biochar:Cobalt promoted wood pine biochar was prepared by an impregnation method. First, 20 g cobalt (II) chloride [CoCl₂, Sigma-Aldrich]) was added to 100 mL DI water. The biochar was added to the solution of cobalt nitrate and stirred for 30 minutes. The mixture was kept at room temperature for 24 h, then transferred to an oven where it was dried at 110° C. for one day.

Preparation molybdenum promoted biochar:Molybdenum promoted wood pine biochar was also prepared using an impregnation method. First, an ammonium heptamolybdate [(NH₄)₆Mo₇O₂₄·4H₂O, Merck] aqueous solution was prepared by adding 100 g of (NH₄)₆Mo₇O₂₄·4H₂O to 500 mL DI water. The mixture of (NH₄)₆Mo₇O₂₄·4H₂O and DI water was heated to 80° C. and a clear solution was obtained. The biochar was added to the solution and stirred at 80° C. for 30 minutes; then was transferred to an oven where it was dried at 110° C. for one day.

Preparation of tungsten-promoted biochar:Tungsten-promoted biochar was prepared using an impregnation method. An ammonium tungstate [(NH₄)₁₀H₂ (W₂O₇)₆, Sigma-Aldrich] aqueous solution was prepared by adding 20 g (NH₄)₁₀H₂ (W₂O₇)₆ to 200 mL DI water. The mixture of (NH₄)₁₀H₂ (W₂O₇)₆ and DI water was heated to 80° C. and a clear solution was obtained. 20 g biochar was added to the solution and stirred at 80° C. for 30 minutes; it was then transferred to an oven where it was dried at 110° C. for one day.

### Examples C1-17: Fabrication of Biochar Composite Materials

Examples C1-C17 describe the fabrication of a variety of biochar composite materials using the disclosed methods.

In these Examples, various techniques were used to characterize the biochar composite materials as well as the components used to fabricate the materials. For example, morphology and microstructure were investigated using scanning electron microscopy (SEM). Samples were coated with gold-palladium alloy of 10-15 nm thickness using a sputter coater prior to SEM examination. Apparent (Da) and true densities (Dt) of samples were measured following standard methods ASTM D 1622 and ASTM D 792-08. The bulk porosity of samples was calculated using the following equation: P(%)=100×((Dt−Da)/(Dt), where P is bulk porosity; Dt is true density and Da is apparent density. ASTM standards were used to determine the mechanical properties of samples. The compression strength was tested according to ASTM Standard C365/C365M-05. The tests were carried out at room temperature on an electron universal testing machine. Thermal conductivity was measured following ASTM Standard E1225 by a laser flash thermal analyzer at room temperature. The fire resistance of the product samples was tested following the standard method of ASTM E 1354. Thermal Gravimetric Analysis (TGA) and Differential scanning calorimetry (DSC) measurements were carried out on binders used to fabricate the biochar composite materials.

Regarding the binders, TGA and DSC tests were conducted on various binders, including corn starch, cellulose, citric acid, carboxymethyl cellulose (CMC), tannin, and Kraft lignin to determine the threshold temperature for each. The results are shown in FIGS. 2A-2F. Different binders may be identified by the characteristics of their TGA and DSC plots. To confirm that thermal treatment converts the binders to a solid, porous, carbonaceous matrix, Scanning Electron Microscopy (SEM) was used to obtain images of various binders after heating at different temperatures. The results are shown in FIGS. 3A-3F. The results confirm the formation of a solid, porous, carbonaceous matrix for each binder but that the morphology differs for each binder. This includes the resulting solid, porous, carbonaceous matrix having different pore dimensions, different pore shapes, and different distribution of pores, depending upon the binder used. Thus, SEM images may be used to identify different binders after thermal treatment. Table 3 lists illustrative binders that may be used as well as a threshold temperature, at or above which temperature thermal treatment provides the solid, porous, carbonaceous matrix.

TABLE 3
Binders and their threshold temperatures.

| Binder | Threshold temperature (° C.) |
|---|---|
| Biorefinery solid residue | ≥120 |
| Black liquor | ≥150 |
| Bio-oil | ≥150 |
| Tannin | ≥175 |
| Sugars and carbohydrates | ≥200 |
| Lignin | ≥200 |
| Pitch | ≥220 |
| Citric acid | 200~300 |
| Carboxymethyl cellulose | ≥250 |
| Soy protein | ≥250 |
| Wheat flour | ≥275 |
| Starch | ≥300 |
| Cellulose | ≥300 |

### Example C1 Biochar Composite Materials Fabricated with Different Binders

In this Example, precursor compositions were prepared by combining 210 grams of biochar (wood biochar) with 90 grams of binder in a blender and mixing very well for 3 minutes. The binders used are listed in Table 4, below. The precursor composition was then transferred into a mold which was shaken several times to level the powder in the mold. The mold with the precursor composition was transferred to a heating chamber and a metal plate was placed on the top of the precursor composition. The heating chamber was then heated at a rate of 1-5° C./min to a temperature between 120-320° C. (see Table 4) and held at this temperature for 20-30 minutes. Next, the mold was cooled down to room temperature and the biochar composite material removed for testing; the results are shown in Table 4.

TABLE 4
Properties of biochar composite materials fabricated with different binders.

| | Heating | Heating | Bulk | | Compressive | Thermal |
|---|---|---|---|---|---|---|
| | temperature | time | Density | Porosity | strength | conductivity |
| Binder | (° C.) | (min.) | (g/cm³) | (%) | (MPa) | (W/m · K) |
| Bio-oil | 120 | 20 | 0.25 ± 0.018 | 86.3 ± 2.5 | 3.9 ± 1.5 | 0.06 ± 0.01 |
| Biorefinery | 150 | 20 | 0.25 ± 0.012 | 86.5 ± 3.3 | 3.6 ± 1.8 | 0.06 ± 0.01 |
| solid residue | | | | | | |
| Tannin | 200 | 30 | 0.24 ± 0.017 | 85.9 ± 3.5 | 3.6 ± 1.9 | 0.06 ± 0.02 |
| Citric acid | 230 | 20 | 0.26 ± 0.015 | 84.9 ± 2.8 | 3.1 ± 1.6 | 0.07 ± 0.02 |
| Powdered cane | 250 | 30 | 0.26 ± 0.019 | 85.7 ± 1.9 | 2.5 ± 1.5 | 0.07 ± 0.02 |
| sugar | | | | | | |
| Black liquor | 230 | 30 | 0.27 ± 0.015 | 84.2 ± 1.5 | 3.9 ± 1.6 | 0.08 ± 0.02 |
| Kraft lignin | 240 | 30 | 0.28 ± 0.012 | 83.9 ± 1.7 | 5.1 ± 1.8 | 0.07 ± 0.02 |
| Carboxymethyl | 280 | 30 | 0.27 ± 0.016 | 85.5 ± 3.8 | 3.3 ± 1.8 | 0.07 ± 0.02 |
| cellulose | | | | | | |
| (CMC) | | | | | | |
| Corn starch | 320 | 30 | 0.31 ± 0.018 | 82.1 ± 1.5 | 4.4 ± 1.7 | 0.07 ± 0.02 |
| Microcellulose | 320 | 30 | 0.26 ± 0.023 | 85.3 ± 2.4 | 1.9 ± 0.4 | 0.06 ± 0.02 |

### Example C2 Effect of Mass Ratio of Biochar:Binder

In this Example, precursor compositions were prepared by mixing various mass ratios (see Table 5) of biochar (wood biochar) and Kraft lignin (moisture content 7.5±0.36%) in a blender and mixing very well for 3 minutes. Each precursor composition was then transferred into a mold. The mold was dropped to the ground several times to level the precursor composition in the mold. The mold was transferred to a heating chamber and a metal plate (¼-inch thickness 314 steel) was placed on the top of the precursor composition. The heating chamber was then heated at a rate of 5° C./min to 240° C. and held for 30 minutes. Next, the mold was cooled down to room temperature and the biochar composite material removed for testing; the results are shown in Table 5. An SEM image of one biochar composite material is shown in FIG. 4 (1:1 mass ratio of biochar:lignin). This image, which labels several individual biochar particles, shows that the biochar composite material is composed of a plurality of distinct biochar particles embedded within and distributed throughout a solid, porous, carbonaceous matrix provided by the binder.

TABLE 5
Properties of biochar composite materials fabricated using different
biochar: binder mass ratios at 240° C..

| | Kraft | Bulk | | Compressive | Thermal |
|---|---|---|---|---|---|
| Biochar | lignin | Density | Porosity | strength | conductivity |
| (g) | (g) | (g/cm³) | (%) | (MPa) | (W/m · K) |
| 240 | 60 | 0.25 ± 0.015 | 85.7 ± 2.9 | 4.6 ± 1.3 | 0.06 ± 0.01 |
| 210 | 90 | 0.28 ± 0.012 | 83.9 ± 1.7 | 5.1 ± 1.8 | 0.07 ± 0.02 |
| 180 | 120 | 0.31 ± 0.018 | 81.8 ± 1.5 | 5.5 ± 1.5 | 0.07 ± 0.02 |
| 150 | 150 | 0.35 ± 0.022 | 79.4 ± 1.3 | 6.8 ± 1.9 | 0.08 ± 0.01 |
| 120 | 180 | 0.40 ± 0.015 | 76.5 ± 1.6 | 8.3 ± 1.5 | 0.09 ± 0.02 |
| 90 | 210 | 0.45 ± 0.019 | 73.5 ± 1.2 | 11.7 ± 1.8 | 0.10 ± 0.02 |

### Example C3 Biochar Composite Materials Fabricated with Different Biochars

The biochar in this Example was prepared by fast pyrolysis at 450° C. using different biomass feedstocks, including wood chips, rice hulls, and wheat straws. For each precursor composition, 210 grams of biochar was combined with 90 grams of carboxymethyl cellulose (CMC) in a blender and mixed very well for 3 minutes. Each precursor composition was then transferred into a mold. The mold was dropped to the ground several times to level the precursor composition in the mold. The precursor composition in the mold was pressed under 1 psig for 1 min at room temperature then transferred to the heating chamber and a metal plate was placed on the top of the precursor composition. The heating chamber was then heated at a rate of 1-5° C./min to 280° C. and held for 30 minutes. Next, the mold was cooled down to room temperature and the biochar composite material removed for testing; the results are shown in Table 6.

TABLE 6
Properties of biochar composite materials fabricated using
different biochars and CMC binder at 280° C..

| | Bulk | | | Thermal |
|---|---|---|---|---|
| | Density | Porosity | Compressive | conductivity |
| Biochar | (g/cm³) | (%) | strength (MPa) | (W/m · K) |
| Wood | 0.29 ± 0.018 | 85.7 ± 2.5 | 3.6 ± 1.5 | 0.06 ± 0.01 |
| biochar | | | | |
| Rice hull | 0.33 ± 0.011 | 82.3 ± 1.8 | 5.1 ± 1.9 | 0.07 ± 0.02 |
| biochar | | | | |
| (RHBC) | | | | |
| Wheat | 0.26 ± 0.017 | 84.6 ± 2.3 | 3.2 ± 1.7 | 0.07 ± 0.02 |
| straw | | | | |
| biochar | | | | |
| (WSBC) | | | | |

### Example C4 Biochar Composite Materials Fabricated Using Modified Biochar (NaOH Modification)

In this Example, the modified biochar that was used was prepared according to Example B1 (various NaOH loadings as shown in Table 7; pyrolysis temperature was 550° C.). For each precursor composition, 210 grams of modified biochar was combined with 90 grams tannin in a blender and mixed very well for 3 minutes. The precursor composition was then transferred into a mold. The mold was dropped to the ground several times to level the precursor composition. The mold was transferred to the heating chamber and a metal plate was placed on the top of the precursor composition. The heating chamber was then heated at a rate of 3° C./min to 240° C. and held for 30 minutes. Next, the mold was cooled down to room temperature and the biochar composite material removed for testing; the results are shown in Table 7. X-ray Diffraction (XRD) was also used to analyze the biochar composite materials (data not shown).

TABLE 7
Properties of biochar composite materials fabricated using modified
biochar (different NaOH loadings) and tannin at 240° C..

| | | | Com- | Sur- | |
|---|---|---|---|---|---|
| | Bulk | | pressive | face | |
| | Density | Porosity | strength | area | pH |
| Biochar (g) | (g/cm³) | (%) | (MPa) | (m²/g) | value |
| 0 wt % NaOH-BC | 0.28 ± 0.019 | 85.3 ± 3.1 | 2.6 ± 0.7 | 211.5 | 8.33 |
| 0.2 wt % NaOH- | 0.29 ± 0.016 | 83.7 ± 2.7 | 2.3 ± 0.8 | 198.3 | 10.95 |
| BC | | | | | |
| 0.5 wt % NaOH- | 0.30 ± 0.018 | 82.8 ± 3.2 | 2.4 ± 0.5 | 189.9 | 11.57 |
| BC | | | | | |
| 1.0 wt % NaOH- | 0.32 ± 0.025 | 82.5 ± 1.9 | 2.6 ± 0.6 | 180.3 | 11.98 |
| BC | | | | | |
| 2.0 wt % NaOH- | 0.35 ± 0.021 | 81.5 ± 2.4 | 2.3 ± 0.5 | 175.4 | 12.45 |
| BC | | | | | |

### Example C5 Biochar Composite Materials Fabricated Using Modified Biochar (Transition Metal Modification)

In this Example, the modified biochar that was used was prepared according to Example B2 (various transition metals as shown in Table 8; pyrolysis temperature was 550° C.). For each precursor composition, 210 grams of modified biochar was combined with 90 grams tannin in a blender and mixed very well for 3 minutes. The precursor composition was then transferred into a mold. The mold was dropped to the ground several times to level the precursor composition. The mold was transferred to the heating chamber and a metal plate was placed on the top of the precursor composition. The heating chamber was then heated at a rate of 1-5° C./min to 240° C. and held for 30 minutes. Next, the mold was cooled down to room temperature and the biochar composite material removed for testing; the results are shown in Table 8.

TABLE 8
Properties of biochar composite materials fabricated using modified
biochar (different transition metals) and tannin at 240° C..

| | Bulk Density | | Compressive strength |
|---|---|---|---|
| Biochar (g) | (g/cm³) | Porosity (%) | (MPa) |
| Fe-Biochar | 0.28 ± 0.015 | 85.7 ± 2.7 | 2.5 ± 0.5 |
| Ni-Biochar | 0.28 ± 0.013 | 84.5 ± 1.5 | 2.2 ± 0.4 |
| Co-Biochar | 0.29 ± 0.011 | 84.2 ± 2.8 | 2.1 ± 0.5 |
| Mo-Biochar | 0.30 ± 0.016 | 83.7 ± 1.9 | 2.1 ± 0.3 |
| W-Biochar | 0.31 ± 0.019 | 83.8 ± 2.3 | 2.2 ± 0.4 |

### Example C6 Biochar Composite Materials Fabricated Using Modified Biochar (NaOH Modification) and Sulfur Modification of Precursor Composition

In this Example, the modified biochar that was used was prepared according to Example B1 (0.5 wt % NaOH; pyrolysis temperature was 550° C.). For the precursor composition, 200 grams of modified biochar was combined with 80 grams biorefinery solid residue and 20 grams of sulfur powder (Sigma-Aldrich) in a blender and mixed very well for 3 minutes. The precursor composition was then transferred into a mold. The mold was dropped to the ground several times to level the precursor composition. The mold was transferred to the heating chamber and a metal plate was placed on the top of the precursor composition. The heating chamber was then heated at a rate of 3° C./min to 150° C. and held for 30 minutes. Next, the mold was cooled down to room temperature and the biochar composite material removed for testing.

Higher temperatures were used during the fabrication of some biochar composite materials, including temperatures from 350° C. to 700° C. (“medium temperature thermal treatment;” Examples C7, C8, C9) and from 700° C. to 1300° C. (“high temperature thermal treatment;” Examples C11-C17). In preparation for these Examples, TGA measurements were first conducted on several biochar-lignin precursor compositions. The resulting TG/DTG curves (data not shown) show a five-stage decomposition over the range of from 30° C. to 900° C. The first stage (30-136° C.) is characterized by a mass loss due to evaporation of physically adsorbed moisture. The second stage (136-255° C.) is mainly attributed to dehydration of chemically bonded water and hydroxyl groups in lignin (binder) and biochar. The third stage (255-423° C.) demonstrates a maximum mass loss which corresponded to the pyrolysis of the lignin component. The peak of the third stage occurred at 394° C. The fourth stage was observed between 423 and 691° C. during which the biochar and pyrolyzed lignin are further decomposed and reconstructed in this temperature range. The fifth stage is found in the temperature range of 691-900° C., during which further carbonization occurs. Beyond this temperature, further carbonization occurs.

### Example C7 Biochar Composite Materials Fabricated Using Different Biochar:Tannin Ratios and Medium-Temperature Thermal Treatment

In this Example, precursor compositions were prepared by mixing various mass ratios (see Table 9) of biochar (wood biochar) and tannin in a blender and mixing very well for 2 minutes. The precursor composition was then transferred into a mold. The mold was dropped to the ground several times to level the precursor composition. The mold was transferred to the heating chamber and a metal plate (¼-inch thickness 314 steel) was placed on the top of the precursor composition. The heating chamber was then heated at a rate of 5° C./min to 450° C. and held for 30 minutes. Next, the mold was cooled down to room temperature and the biochar composite material removed for testing; the results are shown in Table 9. An SEM image of one biochar composite material is shown in FIG. 5 (7:3 mass ratio of biochar:tannin). This image shows that the biochar composite material is composed of a plurality of distinct biochar particles and a solid, porous, carbonaceous matrix provided by the binder. This matrix is present on surfaces and between biochar particles such that neighboring particles are adhered to one another via this matrix.

TABLE 9
Properties of biochar composite materials fabricated using different
biochar: tannin mass ratios at 450° C..

| | | Bulk | | Compressive | Thermal |
|---|---|---|---|---|---|
| Biochar | Tannin | Density | Porosity | strength | conductivity |
| (g) | (g) | (g/cm³) | (%) | (MPa) | (W/m · K) |
| 240 | 60 | 0.27 ± 0.015 | 85.9 ± 1.5 | 2.9 ± 0.7 | 0.06 ± 0.02 |
| 210 | 90 | 0.28 ± 0.014 | 84.7 ± 1.9 | 3.1 ± 0.5 | 0.06 ± 0.02 |
| 180 | 120 | 0.29 ± 0.018 | 84.3 ± 2.5 | 3.3 ± 0.5 | 0.07 ± 0.02 |
| 150 | 150 | 0.31 ± 0.013 | 82.9 ± 2.2 | 3.5 ± 0.6 | 0.07 ± 0.02 |
| 120 | 180 | 0.33 ± 0.016 | 81.5 ± 1.6 | 3.6 ± 0.6 | 0.7 ± 0.02 |
| 90 | 210 | 0.36 ± 0.015 | 79.5 ± 1.9 | 3.9 ± 0.8 | 0.08 ± 0.02 |

### Example C8 Biochar Composite Materials Fabricated with Different Biochars and Medium-Temperature Thermal Treatment

In this Example, 210 grams of different biochars (see Table 10 and Example C3) and 90 grams of starch were combined in a blender and mixed very well for 3 minutes Each precursor composition was then transferred into a mold. The precursor compositions were cold pressed under 5 psig at room temperature then transferred to the heating chamber and a metal plate was placed on the top of the precursor composition. The heating chamber was then heated at a rate of 5° C./min to 450° C. and held for 30 minutes. Next, the mold was cooled down to room temperature and the biochar composite material removed for testing; the results are shown in Table 10.

TABLE 10
Properties of biochar composite materials fabricated using different
biochars and starch binder at 450° C.

| | Bulk | | | Thermal |
|---|---|---|---|---|
| | Density | Porosity | Compressive | conductivity |
| Biochar | (g/cm³) | (%) | strength (MPa) | (W/m · K) |
| Wood BC | 0.31 ± 0.011 | 83.7 ± 1.6 | 3.6 ± 0.4 | 0.07 ± 0.02 |
| RHBC | 0.35 ± 0.015 | 80.5 ± 1.1 | 4.3 ± 0.5 | 0.07 ± 0.02 |
| WSBC | 0.28 ± 0.016 | 85.5 ± 1.5 | 2.6 ± 0.7 | 0.06 ± 0.02 |

### Example C9 Biochar Composite Materials Fabricated from Modified Biochar and Low- and Medium-Temperature Thermal Treatment

The biochar samples used in this Example are those from Examples A1-A4. For each precursor composition, 210 grams of unmodified biochar (BC-AP and BC-VP) or modified biochar (BC-AG-CO₂, BC-AP-H₂O, BC-VG-H₂O, BC-VG-CO₂) and 90 grams of tannin were combined in a blender and mixed very well for 3 minutes. The precursor composition was then transferred into mold and a metal plate was placed on the top of the precursor composition. The mold was transferred to the heating chamber which was then heated at a rate of 5° C./min to 240° C. and held for 30 minutes. Next, the molding chamber was cooled down to room temperature and the biochar composite material removed for testing; the results are shown in Table 11. Additional experiments were carried out as described above but the heating chamber was heated to a higher temperature, specifically, heated at a rate of 5° C./min to 450° C. and held for 30 minutes.

TABLE 11
Properties of biochar composite materials fabricated from modified
biochar.

| | Bulk Density | Porosity | Surface area | Total pore |
|---|---|---|---|---|
| Biochar | (g/cm³) | (%) | (m²/g) | volume (cm³/g) |
| BC-AP | 0.30 ± 0.011 | 82.6 ± 1.1 | 11.9 ± 1.5 | 0.07 ± 0.02 |
| (unmodified) | | | | |
| BC-AG-CO₂ | 0.28 ± 0.015 | 84.9 ± 1.3 | 385 ± 4.7 | 0.10 ± 0.03 |
| BC-VP | 0.29 ± 0.016 | 83.5 ± 1.7 | 215.4 ± 5.2 | 0.09 ± 0.02 |
| (unmodified) | | | | |
| BC-AP-H₂O | 0.27 ± 0.015 | 86.3 ± 2.1 | 719.3 ± 4.3 | 0.11 ± 0.03 |
| BC-VG-H₂O | 0.24 ± 0.021 | 90.2 ± 1.7 | 822.7 ± 1.9 | 0.12 ± 0.02 |
| BC-VG-CO₂ | 0.26 ± 0.019 | 88.5 ± 1.9 | 783.4 ± 3.5 | 0.12 ± 0.03 |

### Example C10 Activation of Biochar Composite Materials

Biochar composite materials fabricated from Examples C1-C5, C7, and C8 were put into a heating chamber. The chamber was heated up to 800° C. under a nitrogen flow and kept at these conditions for 1 hour. Next, a steam flow was introduced to activate these biochar panels at 800° C. for another hour. Next, the chamber was cooled down to room temperature and the activated biochar composite materials removed.

### Example C11 Biochar Composite Materials Fabricated Using Different Binders and High-Temperature Thermal Treatment

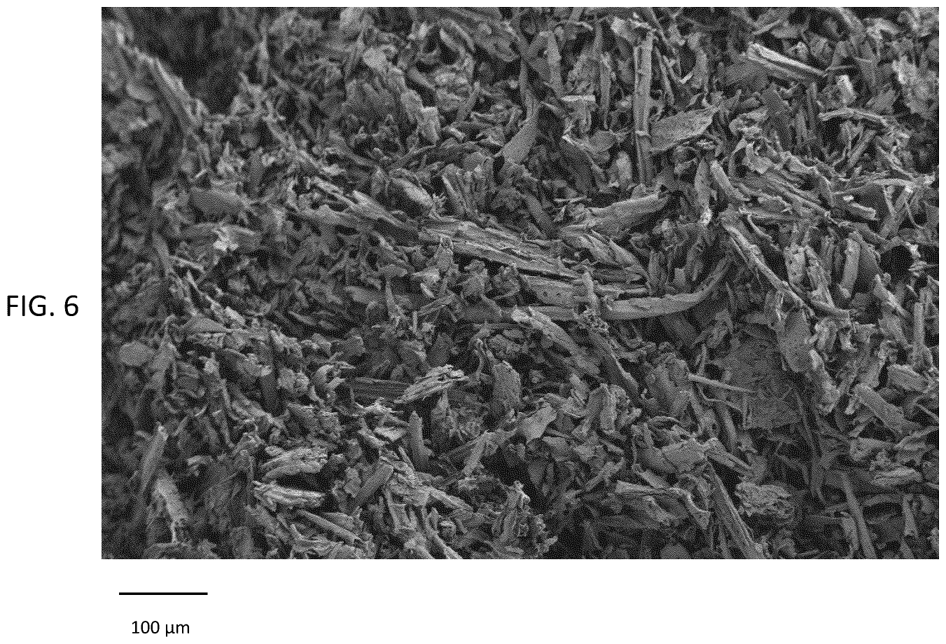

Biochar composite materials fabricated from Example C1 were put into a high temperature furnace, which was heated at a rate of 2° C./min up to 1000° C. under an argon atmosphere and kept at this temperature for 1 hour. Table 12 lists the properties of the biochar composite materials. An SEM image of one biochar composite material is shown in FIG. 6 (7:3 mass ratio of biochar:starch). This image shows that the biochar composite material is composed of a plurality of distinct biochar particles and a solid, porous, carbonaceous matrix provided by the binder. This matrix is present on surfaces and between biochar particles such that neighboring particles are adhered to one another via this matrix. The XRD analysis shows a larger (002) peak as compared to the biochar composite materials of Example C4, consistent with the increased carbonization and greater amount of structured graphitic-like carbon in these biochar composite materials. Thus, the solid, porous, carbonaceous matrix has a higher carbon content as compared to that of biochar composite materials using lower temperature thermal treatments.

TABLE 12
Properties of biochar composite materials fabricated using different
binders and high-temperature thermal treatment.

| | | | Compressive | Thermal |
|---|---|---|---|---|
| | Bulk Density | Porosity | strength | conductivity |
| Binder | (g/cm³) | (%) | (MPa) | (W/m · K) |
| Tannin | 0.29 ± 0.015 | 83.8 ± 2.6 | 9.7 ± 1.1 | 0.07 ± 0.02 |
| Citric acid | 0.28 ± 0.014 | 84.5 ± 1.9 | 4.9 ± 2.3 | 0.07 ± 0.02 |
| Kraft lignin | 0.33 ± 0.017 | 82.6 ± 1.5 | 17.3 ± 1.1 | 0.9 ± 0.03 |
| Carboxymethyl | 0.30 ± 0.009 | 83.1 ± 2.7 | 4.7 ± 1.5 | 0.08 ± 0.02 |
| cellulose (CMC) | | | | |
| Corn starch | 0.32 ± 0.021 | 82.9 ± 1.7 | 7.8 ± 1.7 | 0.08 ± 0.02 |
| Microcellulose | 0.26 ± 0.021 | 85.7 ± 2.6 | 1.5 ± 0.7 | 0.06 ± 0.02 |

### Example C12 Biochar Composite Materials Fabricated Using Different Biochar:Binder Ratios and High-Temperature Thermal Treatment

Biochar composite materials fabricated from Example C2 were put into a high temperature furnace, which was heated at a rate of 2° C./min up to 1000° C. under an argon atmosphere and kept at this temperature for 1 hour. Table 13 lists the properties of the biochar composite materials. SEM images and XRD analysis of the materials were obtained (data not shown).

TABLE 13
Properties of biochar composite materials fabricated using different
biochar:binder ratios and high-temperature thermal treatment.

| | Kraft | Bulk | | Compressive | Thermal |
|---|---|---|---|---|---|
| Biochar | lignin | Density | Porosity | strength | conductivity |
| (g) | (g) | (g/cm³) | (%) | (MPa) | (W/m · K) |
| 240 | 60 | 0.30 ± 0.015 | 83.7 ± 1.2 | 15.1 ± 1.3 | 0.12 ± 0.02 |
| 210 | 90 | 0.33 ± 0.017 | 82.6 ± 1.5 | 17.3 ± 1.1 | 0.15 ± 0.03 |
| 180 | 120 | 0.35 ± 0.019 | 81.6 ± 1.8 | 20.7 ± 1.9 | 0.19 ± 0.03 |
| 150 | 150 | 0.42 ± 0.021 | 77.9 ± 1.5 | 25.0 ± 1.8 | 0.23 ± 0.02 |
| 120 | 180 | 0.50 ± 0.019 | 73.7 ± 1.6 | 31.4 ± 1.5 | 0.27 ± 0.03 |
| 90 | 210 | 0.60 ± 0.025 | 68.4 ± 1.3 | 35.2 ± 1.8 | 0.31 ± 0.05 |

### Example C13 Biochar Composite Materials Fabricated Using High-Temperature Thermal Treatment at Different Temperatures

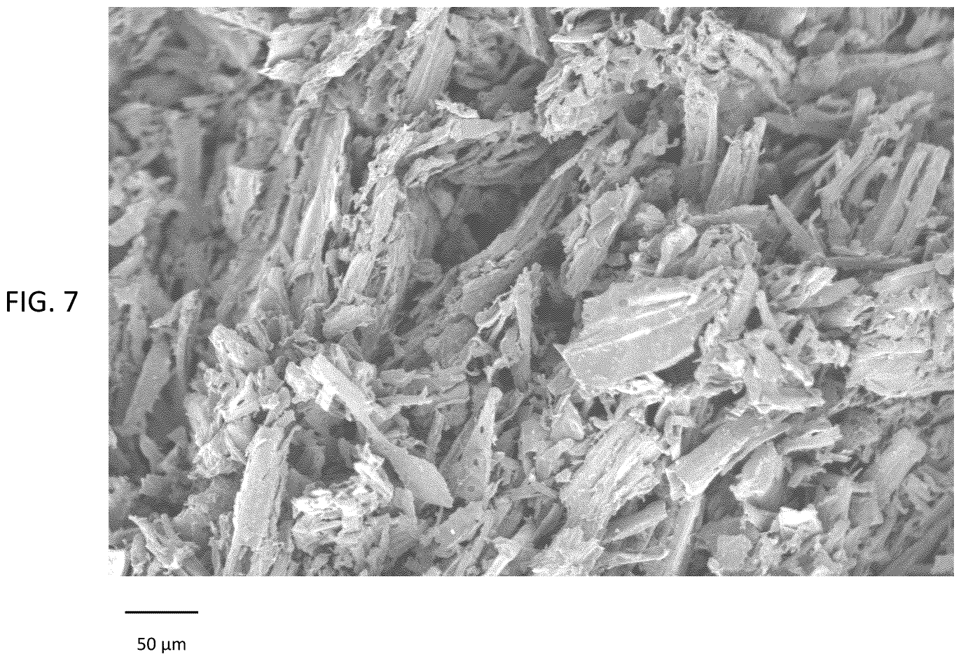

Biochar composite materials fabricated from Example C4 (NaOH loading of 1 weight %). were put into a high temperature furnace, which was heated at a rate of 2° C./min up to various final temperatures as shown in Table 14 under an argon atmosphere and kept at this temperature for 1 hour. Table 14 lists the properties of the biochar composite materials. An SEM image of one biochar composite material is shown in FIG. 7 (7:3 mass ratio of biochar:tannin). This image shows that the biochar composite material is composed of a plurality of distinct biochar particles and a solid, porous, carbonaceous matrix provided by the binder. This matrix is present on surfaces and between biochar particles such that neighboring particles are adhered to one another via this matrix. The XRD analysis shows that the intensity of the (002) peak grows as the temperature increases, consistent with the increased carbonization and greater amount of structured graphitic-like carbon for such biochar composite materials. Thus, the solid, porous, carbonaceous matrix has a higher carbon content as compared to that of biochar composite materials using lower temperature thermal treatments.

TABLE 14
Properties of biochar composite materials fabricated using high-
temperature thermal treatment from 700° C. to 1300° C..

| | Bulk | | | Thermal |
|---|---|---|---|---|
| Temperature | Density | Porosity | Compressive | conductivity |
| (° C.) | (g/cm³) | (%) | strength (MPa) | (W/m · K) |
| 700 | 0.31 ± 0.016 | 84.7 ± 1.8 | 7.2 ± 1.3 | 0.10 ± 0.03 |
| 800 | 0.31 ± 0.015 | 84.5 ± 1.6 | 7.6 ± 0.9 | 0.10 ± 0.02 |
| 900 | 0.32 ± 0.015 | 83.7 ± 1.5 | 8.2 ± 1.1 | 0.11 ± 0.03 |
| 1000 | 0.32 ± 0.013 | 83.2 ± 1.3 | 8.5 ± 0.8 | 0.11 ± 0.02 |
| 1100 | 0.33 ± 0.011 | 82.5 ± 1.4 | 9.1 ± 1.3 | 0.12 ± 0.02 |
| 1200 | 0.34 ± 0.013 | 81.9 ± 1.5 | 9.6 ± 1.5 | 0.13 ± 0.04 |
| 1300 | 0.34 ± 0.015 | 81.5 ± 1.4 | 9.8 ± 1.1 | 0.13 ± 0.03 |

### Example C14 Biochar Composite Materials Fabricated Using Different Cold-Press Pressures and High-Temperature Thermal Treatment

In this Example, 210 grams of wood biochar and 90 grams of kraft lignin were put combined in a blender and mixed very well for 3 minutes. Eight (8) precursor compositions were prepared and then transferred into molds. The precursor compositions were cold pressed under different pressures including 0, 1, 5, 25, 100, 150, 300, and 600 psig. The compressed precursor compositions were transferred in the molds to the heating chamber and a metal plate was placed on the top of each compressed precursor composition. The heating chamber was then heated at a rate of 5° C./min to 450° C. and held for 30 minutes. Next, the molds chambers were cooled down to room temperature and the biochar composite materials were removed and put into the high temperature furnace, which was heated at a rate of 3° C./min to 1000° C. under an argon atmosphere and kept at this temperature for 1 hour. The resulting properties are shown in Table 15. XRD analysis was conducted (data not shown).

TABLE 15
Properties of biochar composite materials fabricated using different
cold-press pressures and high-temperature thermal treatment.

| Cold-press | | | Compressive | Thermal |
|---|---|---|---|---|
| pressure | Bulk Density | | strength | conductivity |
| (psig) | (g/cm³) | Porosity (%) | (MPa) | (W/m · K) |
| 0 | 0.33 ± 0.017 | 82.6 ± 1.5 | 17.3 ± 1.1 | 0.15 ± 0.03 |
| 1 | 0.34 ± 0.013 | 82.1 ± 1.8 | 18.0 ± 1.8 | 0.17 ± 0.03 |
| 5 | 0.36 ± 0.011 | 81.1 ± 1.3 | 18.7 ± 1.9 | 0.18 ± 0.04 |
| 25 | 0.42 ± 0.010 | 77.9 ± 1.5 | 25.3 ± 1.2 | 0.25 ± 0.03 |
| 100 | 0.50 ± 0.015 | 73.7 ± 1.7 | 31.6 ± 1.1 | 0.31 ± 0.03 |
| 150 | 0.56 ± 0.012 | 70.5 ± 1.2 | 33.1 ± 1.6 | 0.35 ± 0.03 |
| 300 | 0.57 ± 0.016 | 70.0 ± 1.5 | 33.9 ± 1.2 | 0.37 ± 0.04 |
| 600 | 0.59 ± 0.011 | 68.9 ± 1.0 | 35.7 ± 1.7 | 0.39 ± 0.03 |

### Example C15 Biochar Composite Materials Fabricated Using Modified Biochar and High-Temperature Thermal Treatment

Biochar composite materials fabricated from Example C5 were put into a high temperature furnace, which was heated at a rate of 3° C./min up to 1000° C. under an argon atmosphere and kept at this temperature for 1 hour. XRD analysis was conducted which confirmed the presence of the respective transition metals incorporated throughout each biochar composite material.

### Example C16 Reinforced Biochar Composite Materials

Biochar composite materials fabricated from Example C2 were put into the high temperature furnace, which was heated at a rate of from about 1 to 20° C./min up to 500° C. under an inert, non-oxidizing atmosphere. Next, an Ar—CH₄ gas flow was introduced and the furnace was heated at a rate of from about 0.5 to 5° C./min up to 800-1100° C. and kept at this temperature for 0.5-5 hours. The properties of the resulting reinforced biochar composite materials are shown in Table 16. SEM images were obtained (data not shown). The images show that the biochar particles are welded together, have smoother outer surfaces, and are coated with a thin carbon film due to the carbon source provided by the Ar—CH₄ gas flow.

TABLE 16
Properties of reinforced biochar composite materials.

| | | | | Compressive | Thermal |
|---|---|---|---|---|---|
| Biochar | Kraft | Bulk Density | Porosity | strength | conductivity |
| (g) | lignin (g) | (g/cm³) | (%) | (MPa) | (W/m · K) |
| 240 | 60 | 0.34 ± 0.012 | 82.1 ± 1.7 | 19.7 ± 1.5 | 0.32 ± 0.07 |
| 210 | 90 | 0.38 ± 0.013 | 80.3 ± 1.8 | 21.7 ± 1.3 | 0.37 ± 0.05 |
| 180 | 120 | 0.39 ± 0.015 | 79.5 ± 1.3 | 23.6 ± 1.5 | 0.39 ± 0.04 |
| 150 | 150 | 0.45 ± 0.017 | 76.3 ± 1.7 | 27.5 ± 1.6 | 0.45 ± 0.07 |
| 120 | 180 | 0.58 ± 0.013 | 72.6 ± 1.8 | 37.9 ± 1.3 | 0.55 ± 0.05 |
| 90 | 210 | 0.62 ± 0.015 | 65.3 ± 1.5 | 41.2 ± 1.9 | 0.61 ± 0.04 |

### Example C17 Reinforced Biochar Composite Materials

In this Example, 210 grams of wood biochar was combined with 90 grams sodium carboxymethyl cellulose (NaCMC) in a blender and mixed very well for 3 minutes. The precursor composition was then transferred into a mold. The mold was shaken several times to level the precursor composition therein. The mold was transferred to the heating chamber and a metal plate was placed on the top of the precursor composition. The heating chamber was then heated at a rate of 3° C./min to 450° C. and held at this temperature for 30 minutes. Next, the mold was cooled down to room temperature. The biochar composite material was then placed in the high temperature furnace, which was heated at a rate of about 10° C./min up to 500° C. under an inert, non-oxidizing atmosphere. Next, an Ar—CH₄ gas flow was introduced and the furnace was heated at a rate of 3° C./min up to 1000° C. and kept at this temperature for 1 hour. A comparative sample was fabricated the same way but using Ar instead of Ar—CH₄. The properties of the resulting biochar composite materials are shown in Table 17. SEM images were obtained (data not shown). The images of the reinforced biochar composite materials show that the biochar particles are welded together, have smoother outer surfaces, and are coated with a thin carbon film due to the carbon source provided by the Ar—CH₄ gas flow. In addition, a plurality of carbon nanofibers extend outwardly from the surfaces of the biochar particles.

TABLE 17
Properties of reinforced biochar composite materials (and a
comparative biochar composite material).

| | Bulk | | | Thermal |
|---|---|---|---|---|
| | Density | Porosity | Compressive | conductivity |
| Atmosphere | (g/cm³) | (%) | strength (MPa) | (W/m · K) |
| Argon | 0.32 ± 0.015 | 83.9 ± 1.5 | 7.3 ± 1.5 | 0.25 ± 0.03 |
| (comparative) | | | | |
| Ar-CH₄ | 0.35 ± 0.018 | 80.4 ± 1.8 | 11.5 ± 1.4 | 0.29 ± 0.02 |

### Examples D1-D3: Applications of Biochar Composite Materials

Examples D1-D3 describe the use of various biochar composite materials in different applications.

### Example D1 Utilization of Biochar Composite Materials for Heavy Metal Removal

In this Example, the biochar composite material fabricated in Example C4 (1.0 weight % NaOH—BC) was tested for heavy metal removal from wastewater. Four stock solutions containing a metal salt in water were prepared (Cd(NO₃)₂·4H₂O, Cr(NO₃)₃·9H₂O, Ni(NO₃)₂·6H₂O, Pb(NO₃) in which the initial concentration of each metal was about 70 ppm. To each stock solution, about 1.3 g of the biochar composite material was added and the mixture shaken at 15 rpm. At multiple time points (0, 5, 24, 48 hours, 3, and 4 days), a 5 mL aliquot was taken from the mixture and filtered through a 0.45 μm filter. Heavy metal analysis was done on each aliquot using an automated Hg analyzer (ICP-OES). The test results are reported in Table 18.

TABLE 18
Removal of heavy metals using biochar composite material.

| | Concentration of Metal Ions (ppm) | | | |
|---|---|---|---|---|
| Time | Pb²⁺ | Cr³⁺ | Cd²⁺ | Ni²⁺ |
| 0 hr | 71.49 | 72.32 | 84.0 | 72.99 |
| 5 hr | 35.91 | 42.79 | 80.90 | 69.6 |
| 24 hr | 0.88 | 6.35 | 74.95 | 66.01 |
| 48 hr | 0.2 | 0.27 | 67.33 | 61.28 |
| 3 day | 0.07 | 0 | 68.30 | 65.08 |
| 4 day | 0.03 | 0 | 62.29 | 59.99 |
| Adsorption Efficiency after 4 days | 99.9% | 100% | 26% | 18% |

Next, the biochar composite material fabricated in Example C6 (0.5 weight % NaOH—BC and sulfur activation) was tested for mercury removal from wastewater. Samples of about 1.2 g of the biochar composite material was first soaked in DI water for 3 hours prior to experiment. Each sample was added to 250 mL of DI that had been spiked with 2 ppm Hg (Mercury(II) nitrate monohydrate from Sigma-Aldrich). The test beakers were either shaken (15 rpm) or not shaken during the testing process. At multiple time points (0, 1, 2, 4, 6, 24, 48 hours) a 5 mL aliquot was taken from each test beaker and filtered through a 0.45 μm filter. Filtered samples were preserved to 1% HCl. Hg analysis was done using an automated Hg analyzer (ICP-MS) following a modified version of USEPA Method 1631. The mercury concentration at the various time points for the various samples are reported in Table 19.

TABLE 19
Removal of mercury using biochar composite material.

| | Hg concentration (ng/mL) | | | | | |
|---|---|---|---|---|---|---|
| | Shaken | | | Not Shaken | | |
| Time (hrs) | Run1 | Run2 | Run3 | Run1 | Run2 | Run3 |
| 0 | 2083 | 2075 | 2042 | 2109 | 2215 | 2127 |
| 1 | 1425 | 1406 | 1423 | 1542 | 1489 | 1513 |
| 2 | 1076 | 1051 | 1015 | 1265 | 1202 | 1238 |
| 4 | 724 | 705 | 696 | 841 | 785 | 783 |
| 6 | 551 | 540 | 535 | 668 | 679 | 665 |
| 24 | 270 | 255 | 247 | 315 | 348 | 326 |
| 48 | 65 | 71 | 53 | 80 | 72 | 67 |
| Absorption Efficiency after 48 hr | 96.9% | 96.6% | 97.4% | 96.2% | 96.7% | 96.9% |

### Example D2 Utilization of Biochar Composite Materials for PFAS Removal

In this Example, the biochar composite material fabricated in Example C8 (70% BC-30% starch) was tested for PFAS removal from wastewater. One piece of the biochar composite material was added to 400 mL of DI that had been spiked with 70 ppt perfluorooctanoic acid (PFOA). The test beaker was shaken (150 rpm) during the testing process. At multiple time points (0, 1, 3, 24, 48 hours), the sample was analyzed using a HPLC/LC-MS-MS system. The PFOA concentration at the various time points are reported in Table 20.

TABLE 20
Removal of PFAS using biochar composite material.

| Test time | Concentration of PFOA | Adsorption efficiency |
|---|---|---|
| (hour) | (ppt) | (%) |
| 0 hr | 70.4977 | — |
| 1 hr | 3.3792 | 95.21 |
| 3 hr | 3.5471 | 95 |
| 24 hr | 1.6868 | 97.61 |
| 48 hr | 2.6469 | 96.25 |

### Example D3. Utilization of Biochar Composite Materials for Fire Resistance

The biochar composite materials fabricated above exhibit tremendous fire-resistant properties. For example, no damage was observed after being exposed to a 1150° C. acetylene torch. The biochar composite materials will not support combustion because they are made from hard carbon (sp³ hybridized carbon), which is one of the best materials available in high-temperature applications, such as those experienced during fires. ASTM E136 tests materials in a 750° C. environment for combustibility with three metrics for passing: combustibility, mass loss, and temperature rise. The biochar composite materials underwent the ASTM E136 test using a vertical furnace at 750° C. in air, proving that the material resists combustion.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.” The terms “comprising” and the like may be replaced by the terms “consisting” and the like.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

What is claimed is:

1. A method of fabricating a biochar composite product, the method comprising thermally treating a precursor composition by heating the precursor composition according to a heating profile to provide a biochar composite product, the precursor composition comprising biochar and a natural binder other than lignin, wherein the natural binder forms a solid, porous, covalently bound carbon matrix at or above a threshold temperature, wherein the biochar composite product comprises a plurality of porous, carbonaceous particles and the solid, porous, covalently bound carbon matrix on surfaces of particles in the plurality such that neighboring particles are adhered together.

2. The method of claim 1, wherein particles in the plurality of porous, carbonaceous particles have elongated, rectangular shapes with ragged edges and an average largest dimension in a range of from 1 mm to 100 mm.

3. The method of claim 1, wherein the biochar is unmodified biochar.

4. The method of claim 1, wherein the method further comprises exposing the biochar or the precursor composition or both to an activation agent to provide modified biochar.

5. The method of claim 4, wherein the activation agent is selected from steam, CO₂, a base, an acid, or a metal precursor.

6. The method of claim 1, wherein the natural binder is selected from the group consisting of starch, tannin, carboxymethyl cellulose, biorefinery solid residue, and bio-oil.

7. The method of claim 4, wherein the activation agent is selected from steam, a base, and an acid and wherein the natural binder is selected from the group consisting of starch, tannin, and carboxymethyl cellulose.

8. The method of claim 1, wherein the precursor composition comprises more biochar than natural binder.

9. The method of claim 8, wherein the precursor composition has a mass ratio of biochar:natural binder that is at least 2:1.

10. The method of claim 1, wherein the precursor composition consists of the biochar and the natural binder.

11. The method of claim 1, wherein the heating according to the heating profile uses a maximum temperature that is between the threshold temperature and less than 320° C.

12. The method of claim 1, wherein the heating according to the heating profile uses a maximum temperature that is between 350° C. and less than 800° C.

13. The method of claim 1, wherein the heating according to the heating profile uses a maximum temperature that is from greater than 800° C. to 1300° C.

14. The method of claim 1, wherein a source of gaseous hydrocarbons is provided during the thermal treatment to provide a reinforced biochar composite product.

15. The method of claim 1, wherein the method further comprises exposing the biochar composite product to an activation agent to provide an activated biochar composite product.

16. A biochar composite product comprising a plurality of porous, carbonaceous particles and a solid, porous, covalently bound carbon matrix on surfaces of particles in the plurality such that neighboring particles are adhered together to form the biochar composite product as a solid, unitary, monolithic, free-standing structure.

17. The biochar composite product of claim 16, wherein particles in the plurality of porous, carbonaceous particles have elongated, rectangular shapes with ragged edges and an average largest dimension in a range of from 1 mm to 500 mm.

18. A method of using the biochar composite product of claim 16, the method comprising passing a fluid medium comprising an impurity through the biochar composite product, wherein after passage, the fluid medium has a decreased amount of the impurity as compared to prior to passage.

19. The method of claim 18, wherein the fluid medium is wastewater and the impurity is a metal, a PFAS, or both.
